(19) United States
(12) Patent Application Publication
(10) Pub. No.: US 2018/0069815 A1
(43) Pub. Date: Mar. 8, 2018

(54) APPLICATION-BASED MESSAGING SYSTEM USING HEADPHONES

(71) Applicant: Bose Corporation, Framingham, MA (US)

(72) Inventors: Gustavo Fontana, Framingham, MA (US); Joseph M. Geiger, Clinton, MA (US); Maximilian Kiener, Munich (DE)

(21) Appl. No.: 15/694,036

(22) Filed: Sep. 1, 2017

Related U.S. Application Data
(60) Provisional application No. 62/383,011, filed on Sep. 2, 2016.

(51) Int. Cl. H04L 12/58

(52) U.S. Cl. CPC H04L 51/066; H04L 51/38; H04L 51/10; H04L 51/04

(57) ABSTRACT

A system and method for exchanging electronic messages between a mobile electronic device of a first party of a communication including the electronic messages and a mobile electronic device of a second party of the communication, comprises outputting an electronic message in a first format from one of the mobile electronic devices; reading the electronic message in the first format; transcribing the electronic message into a second format; outputting the electronic message in both the first format and the second format to the other of the mobile electronic devices; and selecting by a user of the other of the mobile electronic devices at least one of the first and second formats.

### RELATED APPLICATIONS

This application claims the benefit of U.S. Provisional Patent No. 62/383,011, filed Sep. 2, 2016, entitled “Application-Based Messaging System Using Headphones,” the contents of which are incorporated by reference herein in their entirety.

### BACKGROUND

This description relates generally to electronic messaging, and more specifically, to an application-based messaging platform that provides techniques for exchanging electronic text and/or voice messages.

### BRIEF SUMMARY

In accordance with one aspect, a method for exchanging electronic messages between a mobile electronic device of a first party of a communication including the electronic messages and a mobile electronic device of a second party of the communication, comprises outputting an electronic message in a first format from one of the mobile electronic devices; reading the electronic message in the first format; transcribing the electronic message into a second format; outputting the electronic message in both the first format and the second format to the other of the mobile electronic devices; and selecting by a user of the other of the mobile electronic devices at least one of the first and second formats.

Aspects may include one or more of the following features:

The mobile electronic device of the first party may comprise a headset.

The mobile electronic device of the second party may comprise a mobile phone.

The first format may a voice recording, and the second format may be a text message.

The other of the mobile electronic devices may include a user-selectable feature for selecting whether to receive the message in the first format or the second format.

The method may further comprise determining from context data a language of preference of the other of the mobile electronic devices; and translating the content of the electronic message into the second format, the second format in the language of the preference.

The method may further comprise processing context data to determine whether to deliver the message in the first format or the second format to the other mobile electronic devices.

The method may further comprise automatically switching from an asynchronous mode to a synchronous mode during the communication.

The asynchronous mode may include a text-based or voice-based messaging exchange, and the synchronous mode may include a real-time or near real-time communication.

The method may further comprise generating an auto reply, wherein in response to receiving the electronic message by the other of the mobile electronic devices, the method further may include automatically recording sound to capture a voice reply; outputting the recorded sound to a messaging system; transcribing the recorded sound into a text message; and outputting the text message.

The message in the first format may be output to a cloud based transcription service to be transcribed.

The method may further comprise grouping a plurality of electronic messages according to a predetermined conversation.

The electronic messages may include both synchronous and asynchronous messages, and the method may further comprise combining the synchronous and asynchronous messages in the communication.

In accordance with one aspect, a messaging platform comprises at least one input for receiving an electronic message in a first format from one of a headset and a mobile electronic device; and a special-purpose processor for determining whether the receiving other of the headset and the mobile electronic device is configured for processing the electronic message in the first format, and for providing to the other of the headset and the mobile electronic device at least one of the electronic message converted into a second format or in the first format.

Aspects may include one or more of the following features:

One of the first format and the second format may be a voice recording and the other of the first format and the second format maybe a text message.

In another aspect, a system for exchanging electronic messages comprises a headset; an application stored at and executed by a mobile electronic device; and a messaging system for exchanging voice messages processed by the headset and a combination of voice and text messages processed by the application.

Aspects may include one or more of the following features:

The messaging system may convert a voice message of the voice messages processed by the headset to a text message for receipt by the mobile electronic device.

### BRIEF DESCRIPTION

The above and further advantages of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

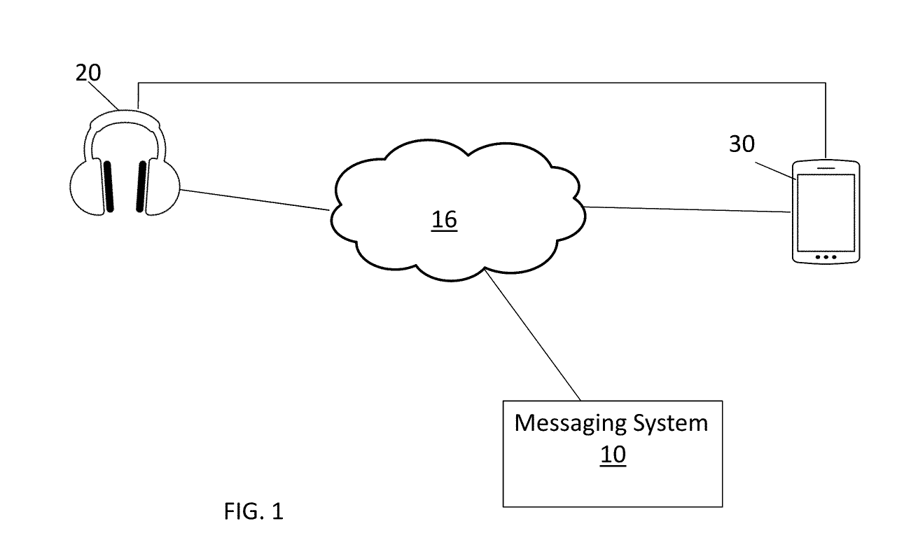

FIG. 1 is a diagram of an environment in which examples of a system and method for performing electronic messaging may be practiced.

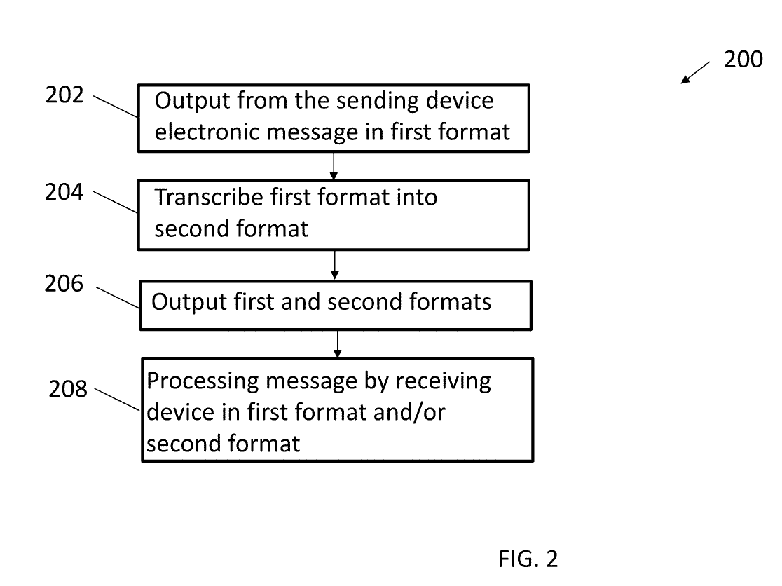

FIG. 2 is a flowchart illustrating an example of a method for providing bidirectional communication between disparate electronic devices.

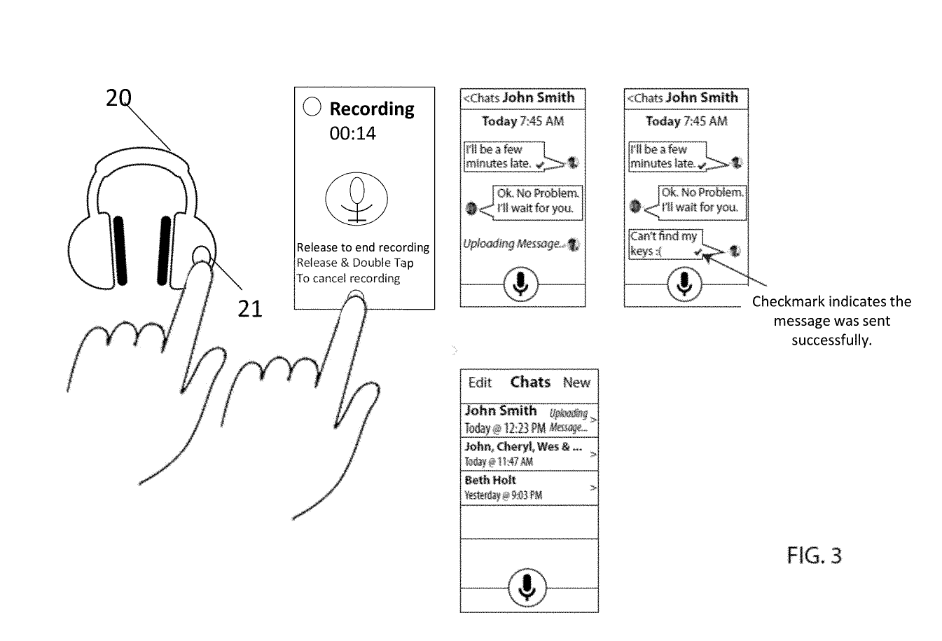

FIG. 3 is a flow diagram illustrating an example of a recording process including user interface screenshots.

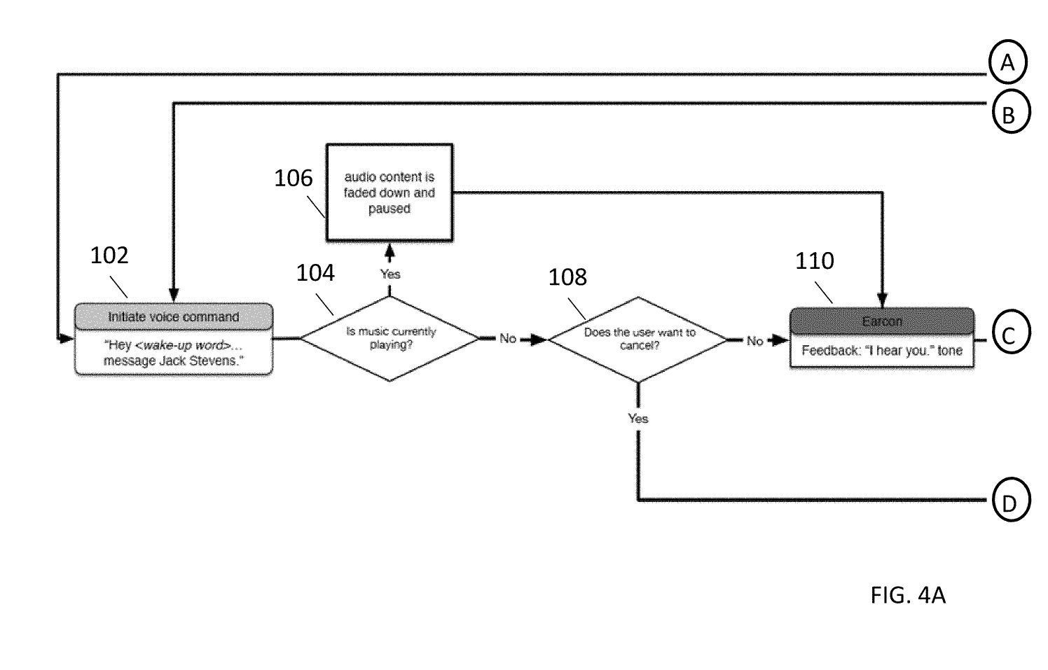

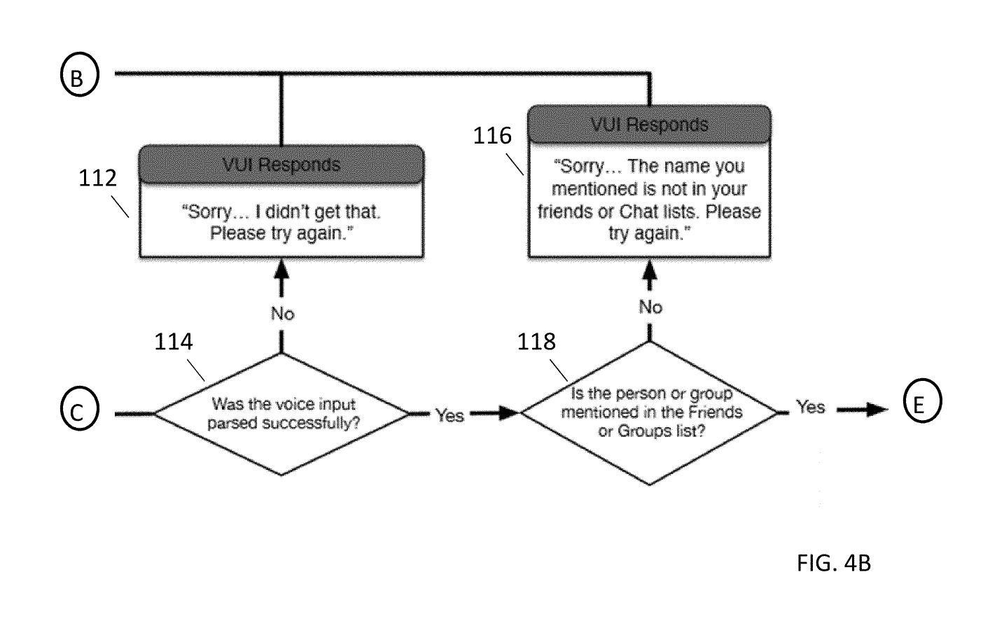

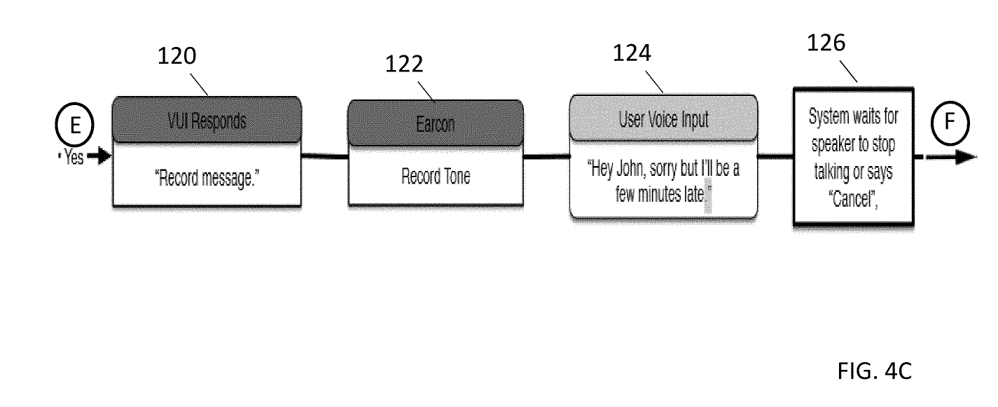

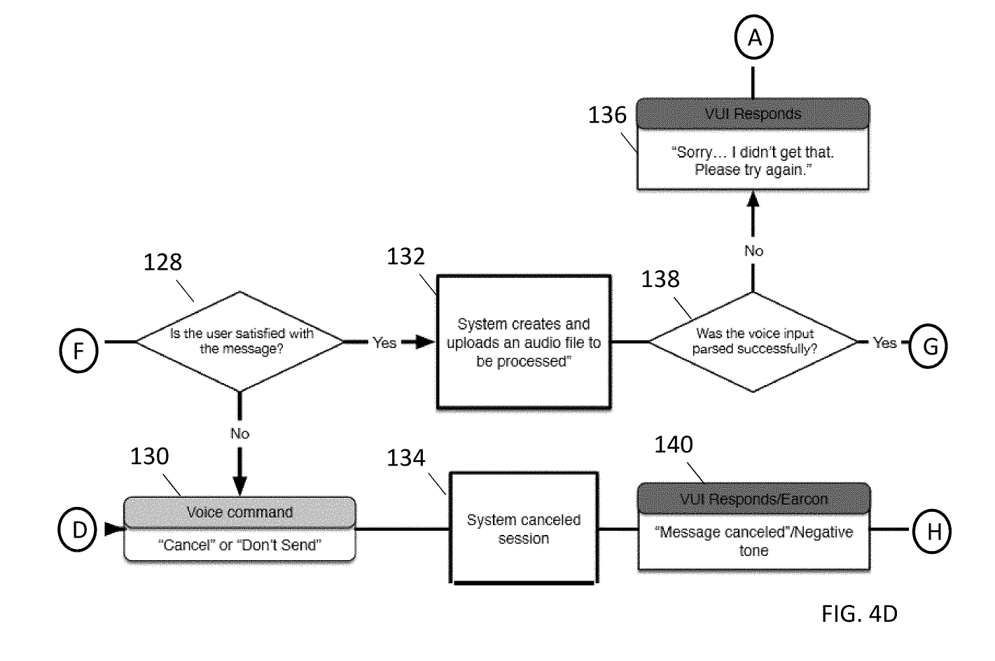

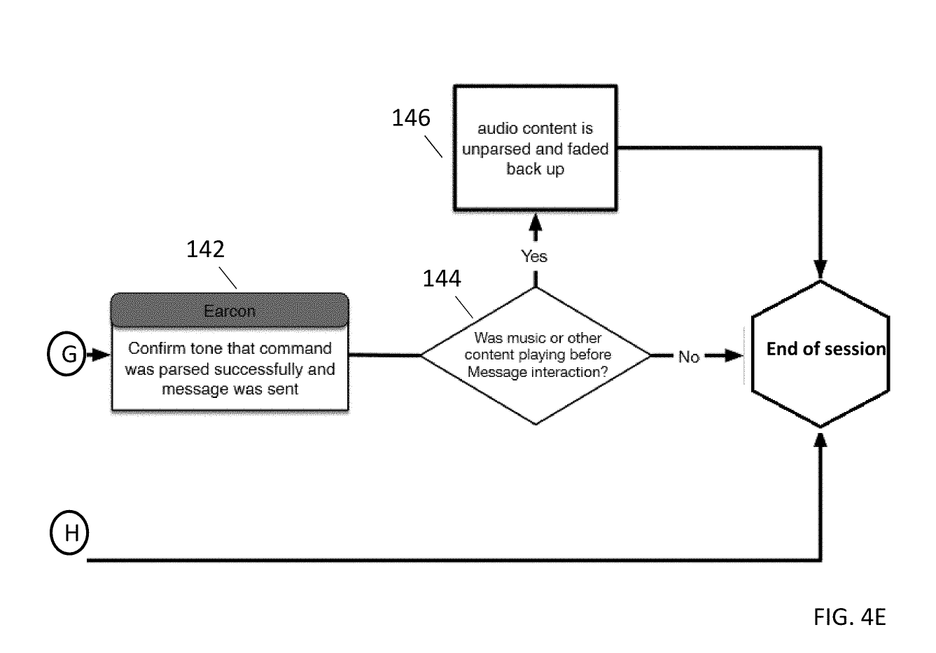

FIGS. 4A-4E are flow diagrams illustrating an example of a hands-free operation for initiating a communication exchange.

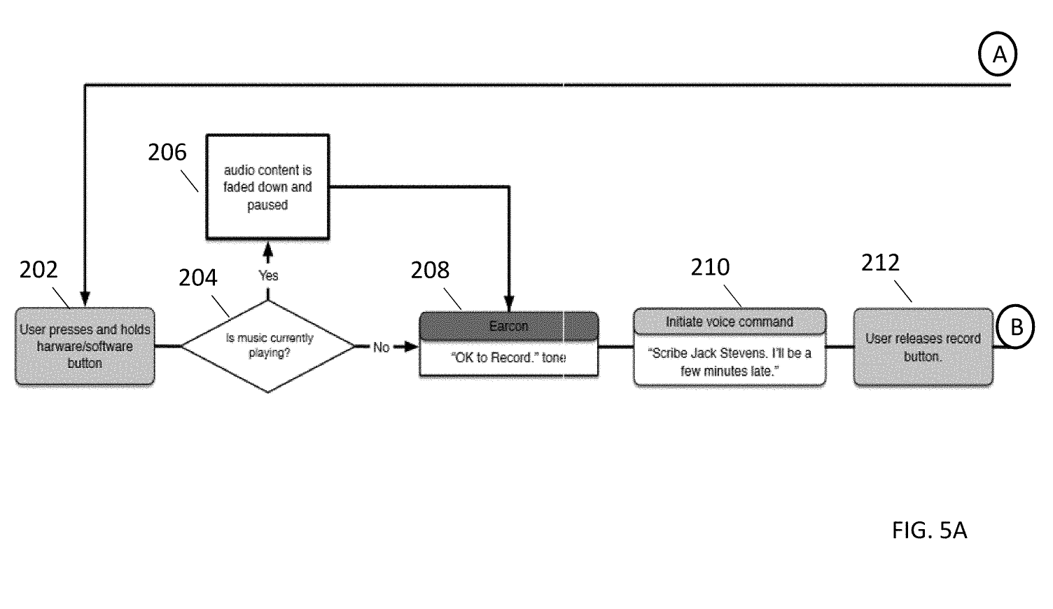

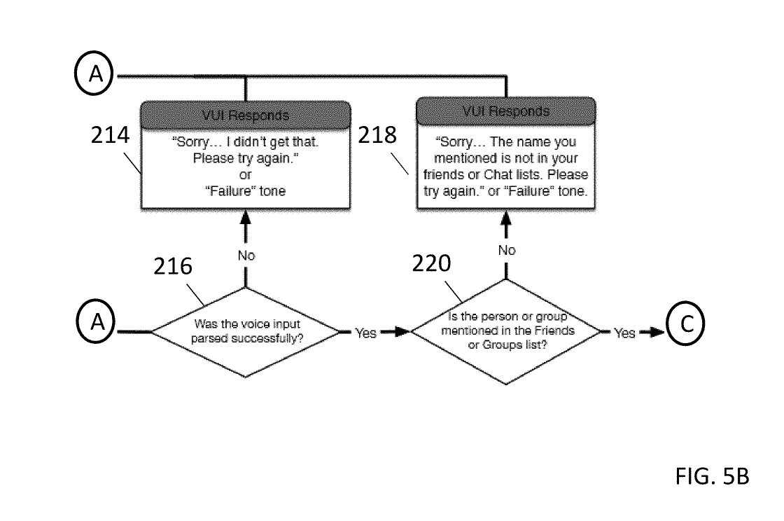

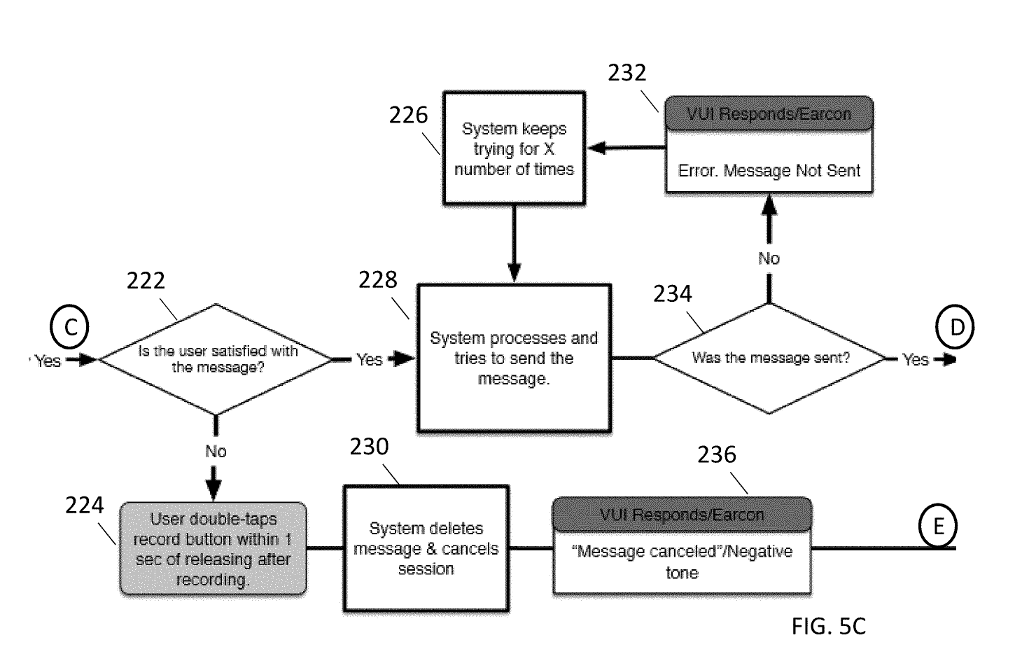

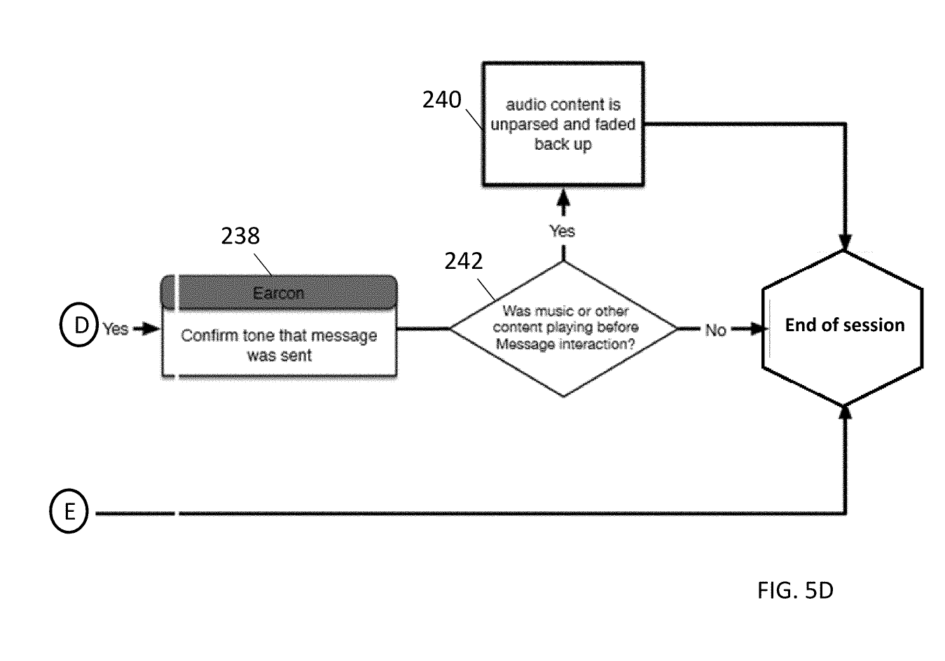

FIGS. 5A-5D are flow diagrams illustrating an example of a hands-free operation that includes sending a message using a hardware or software button.

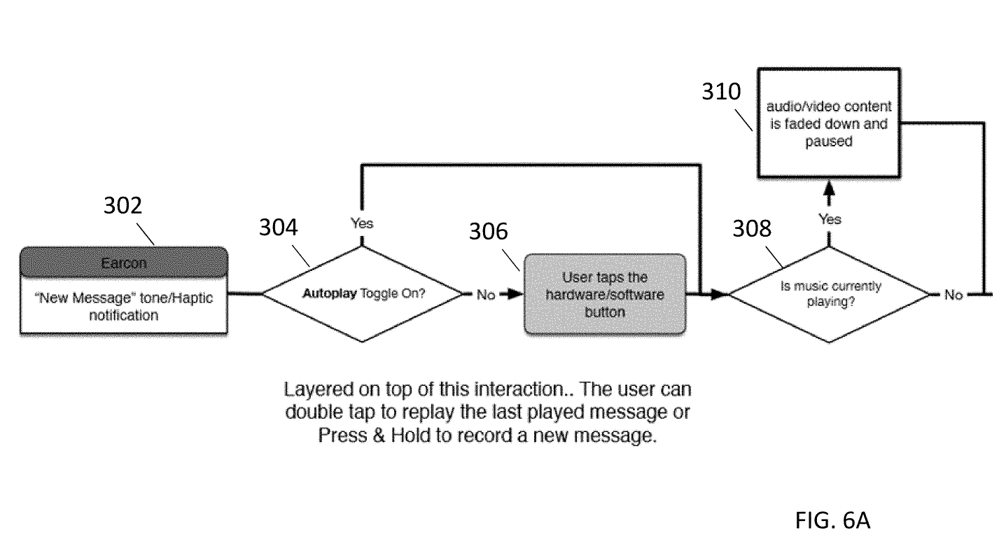

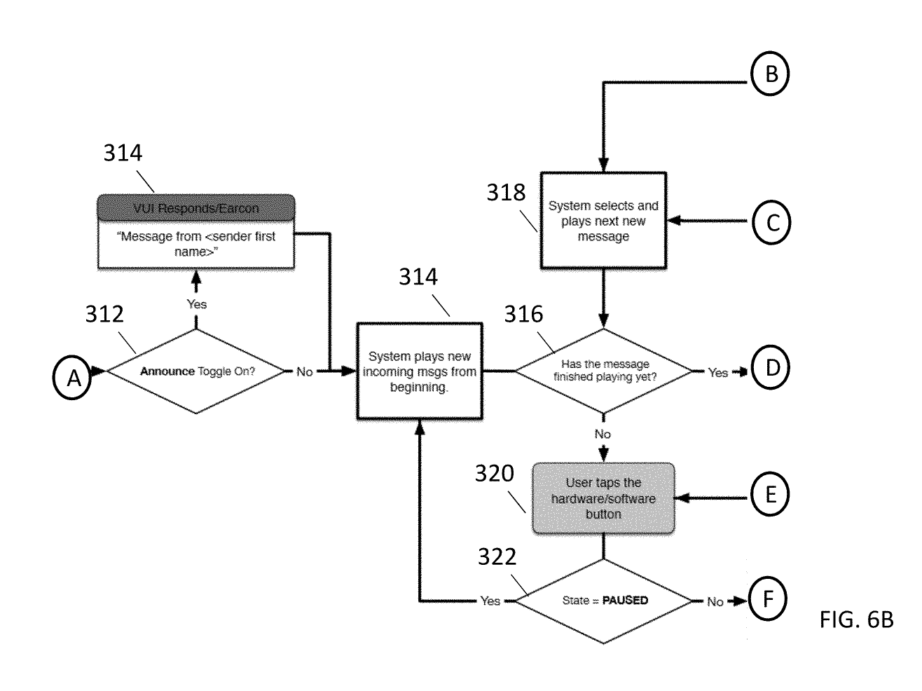

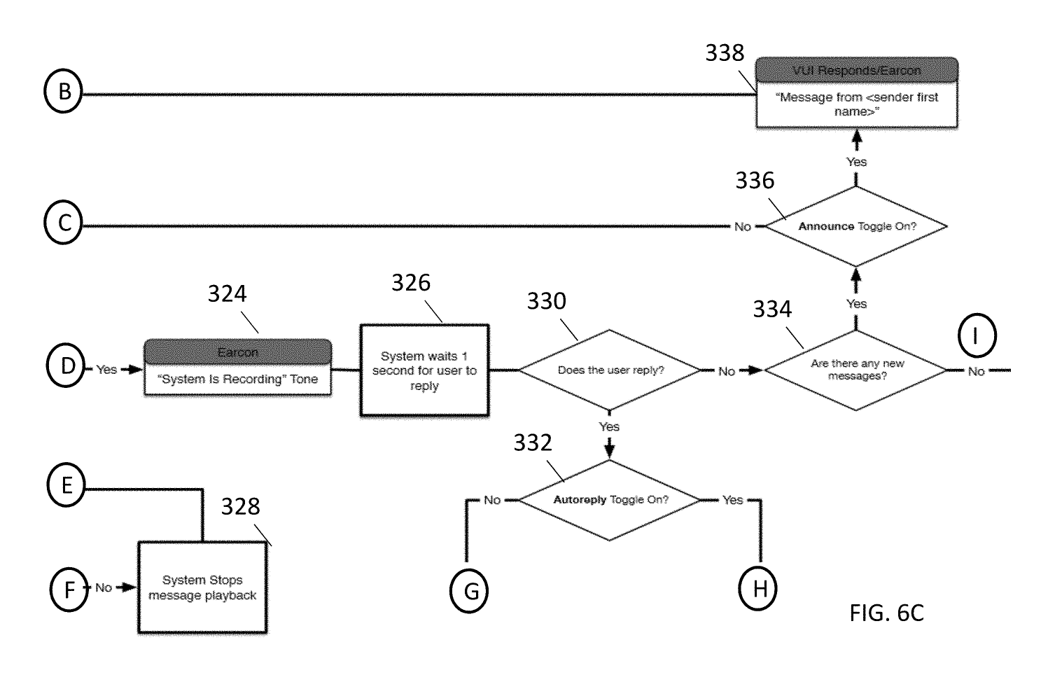

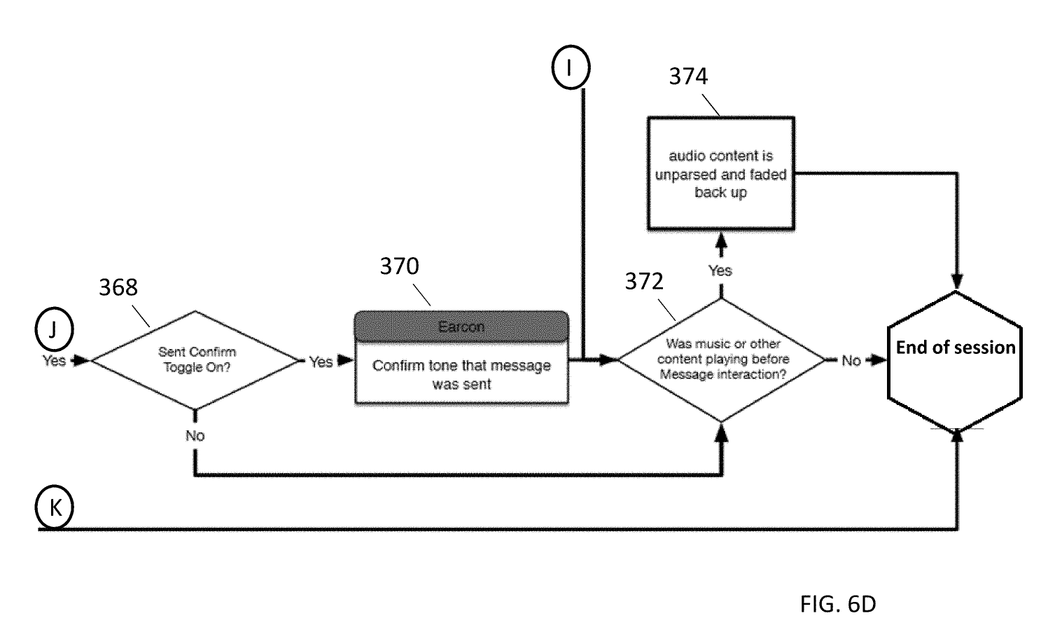

FIGS. 6A-6D are flow diagrams illustrating an example of a method for processing a received message in a communication exchange.

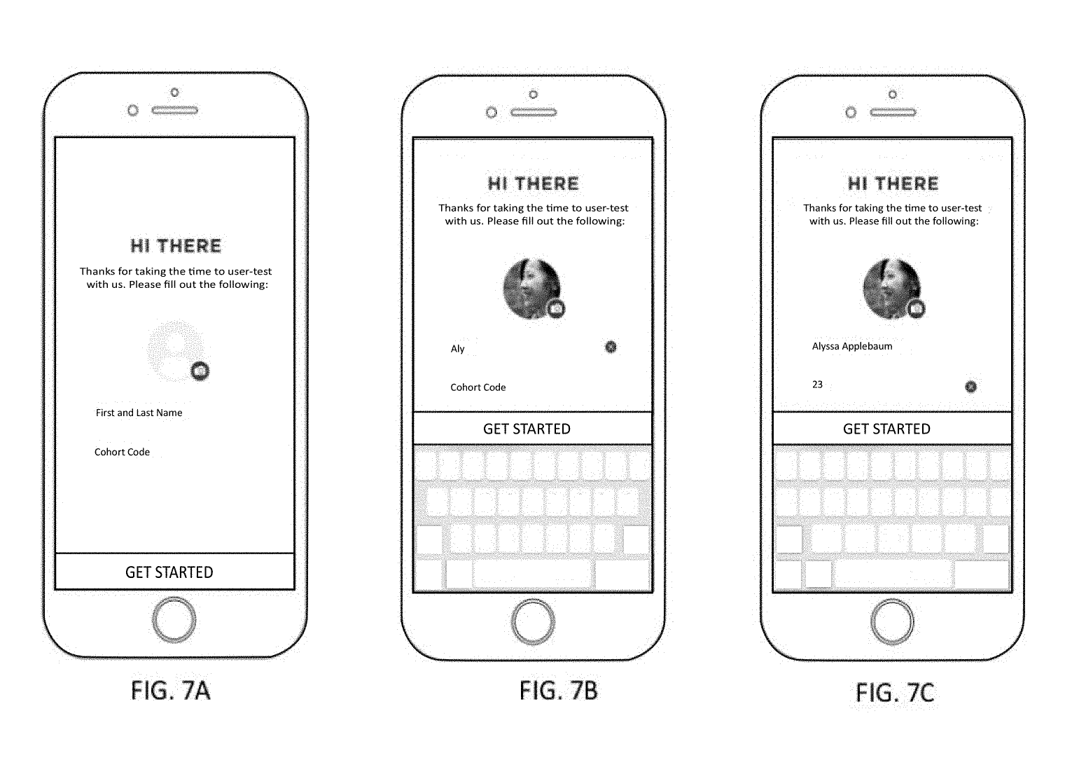

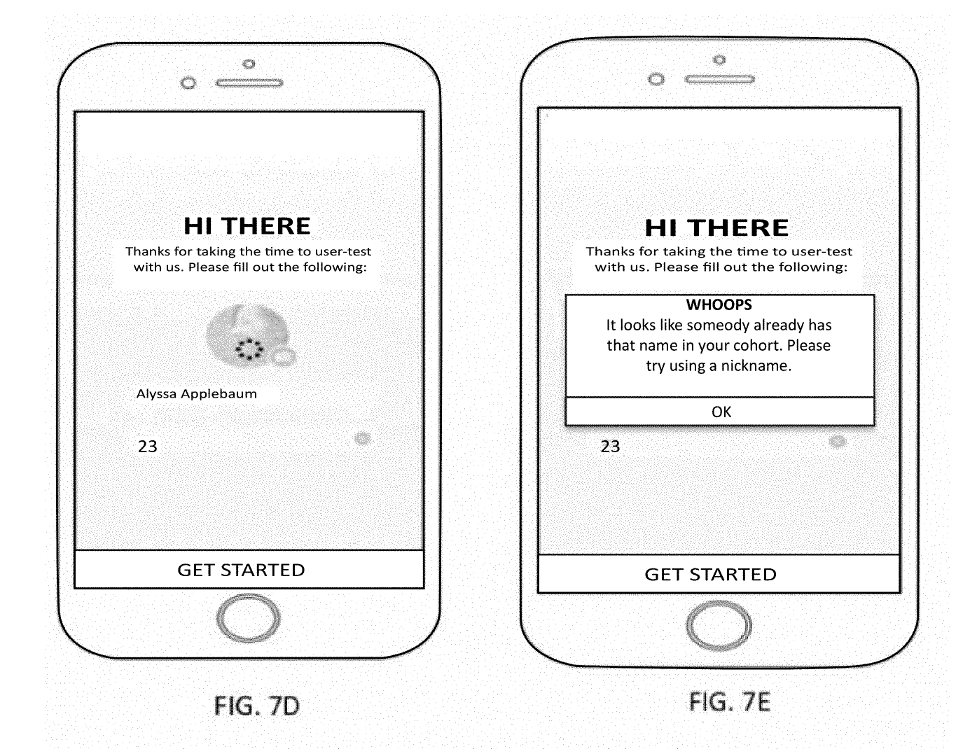

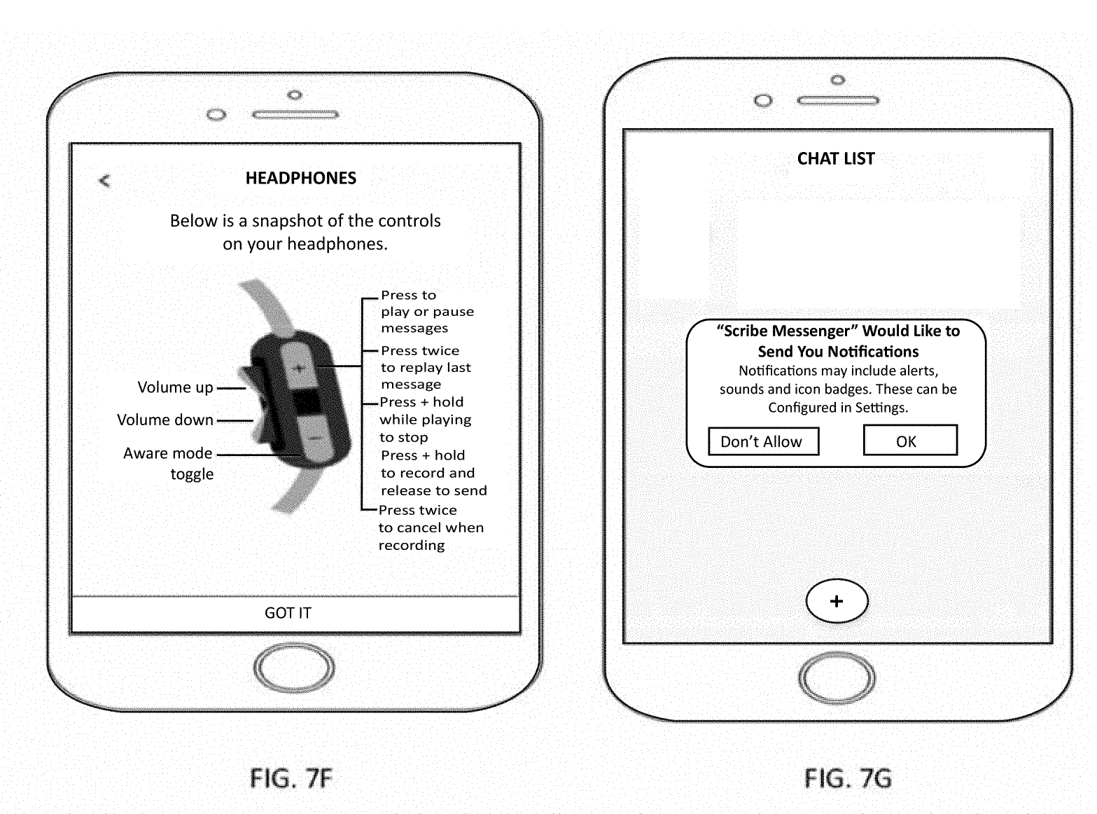

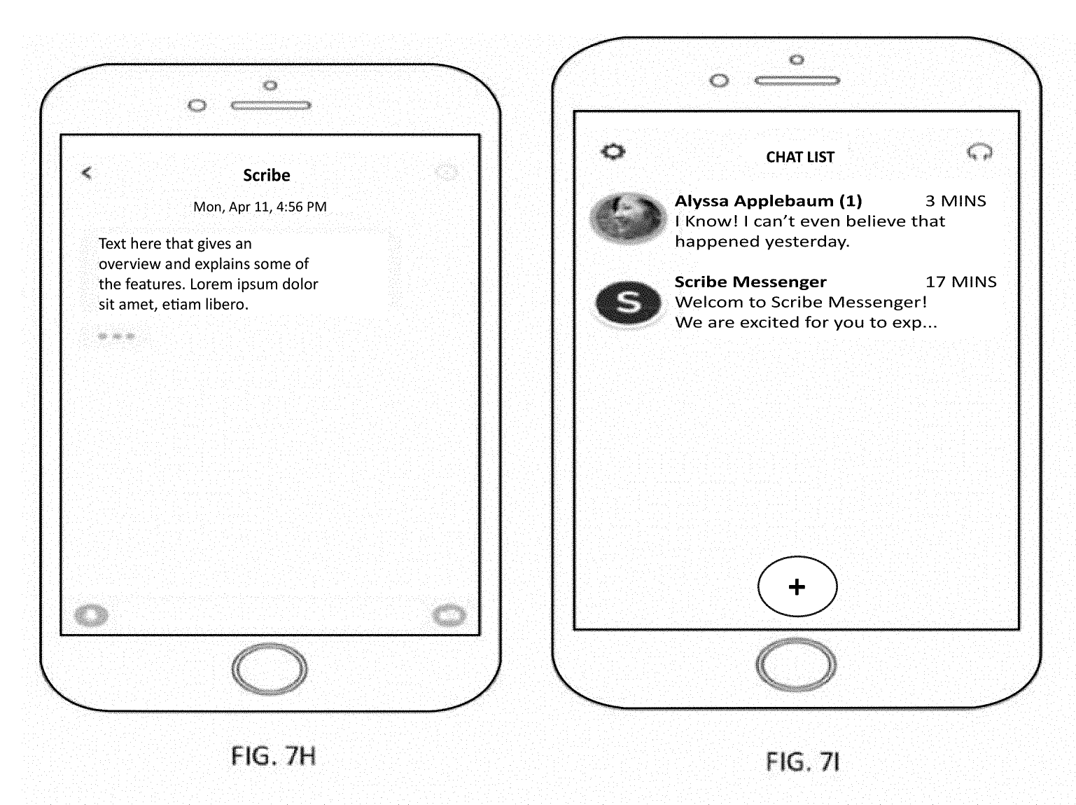

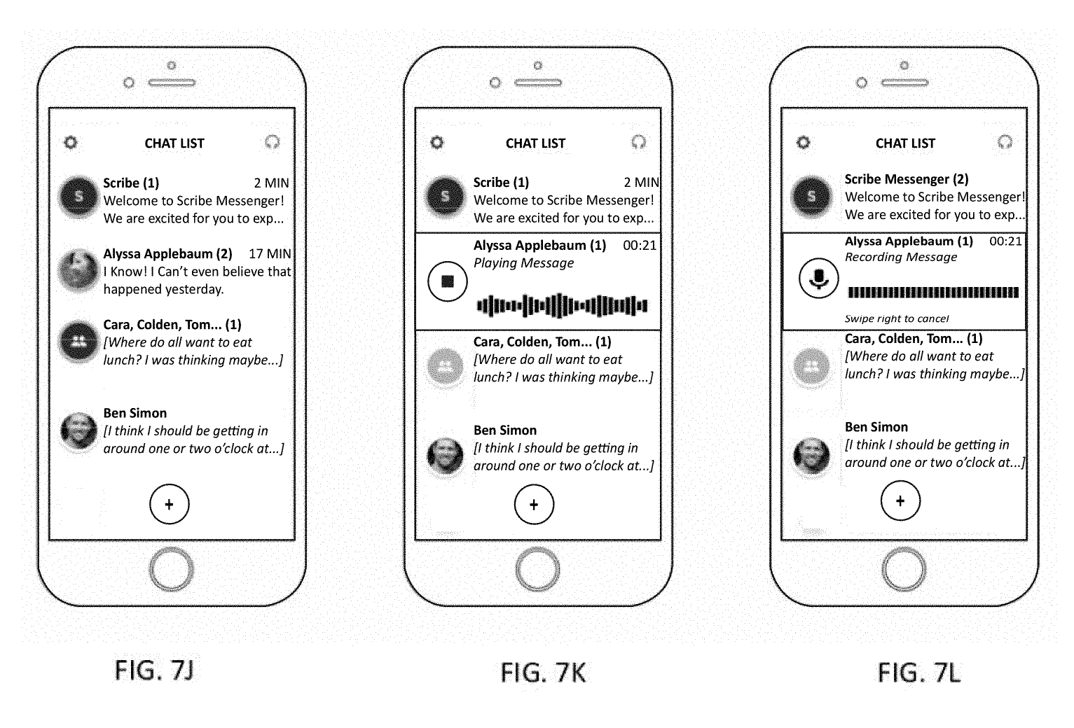

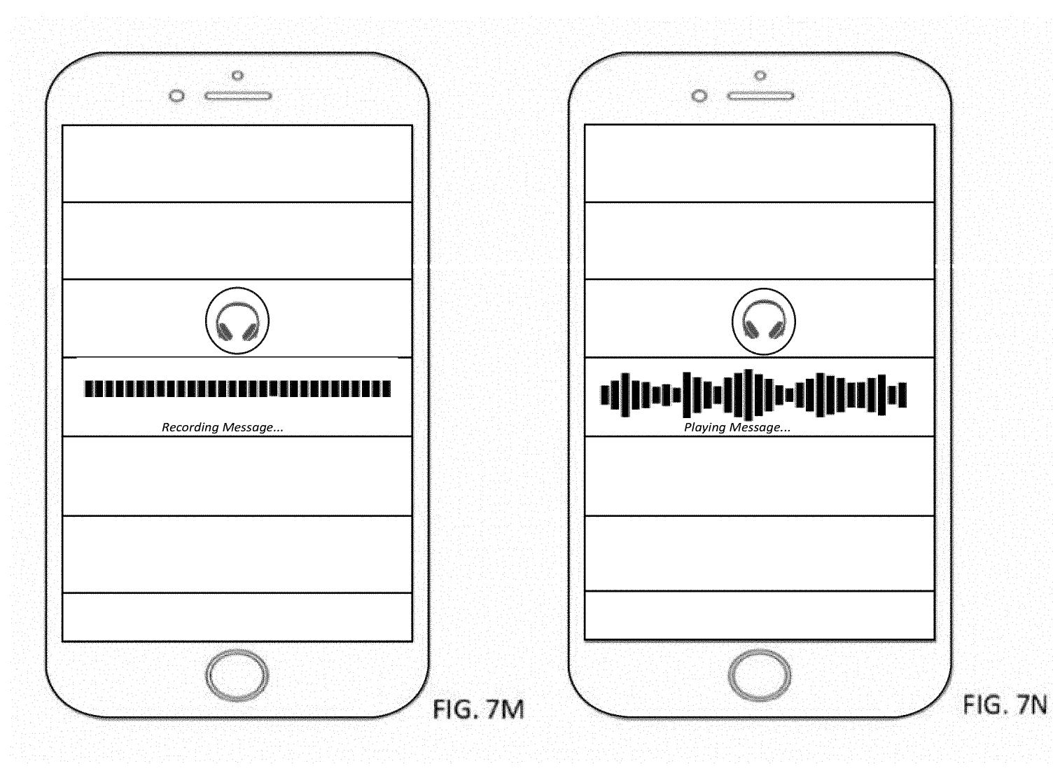

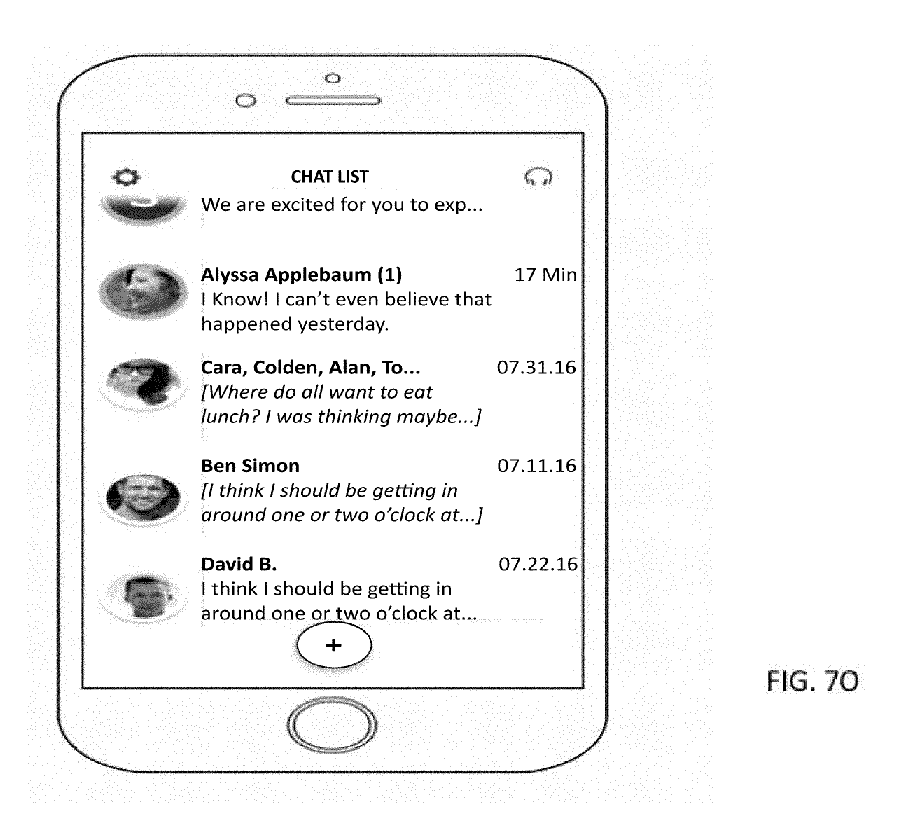

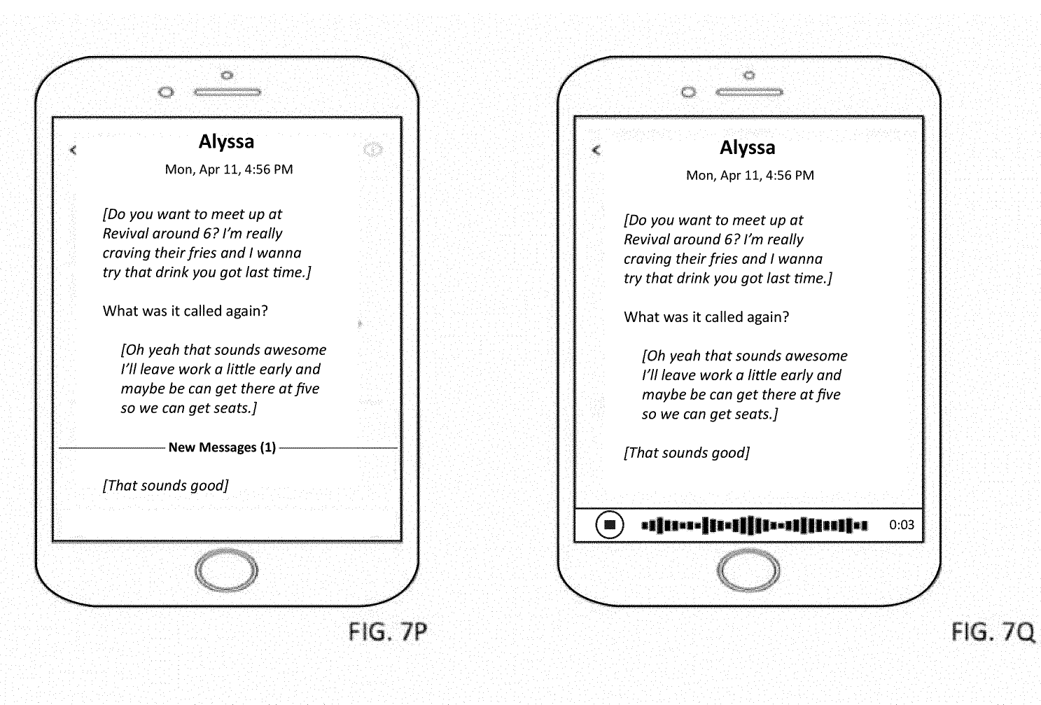

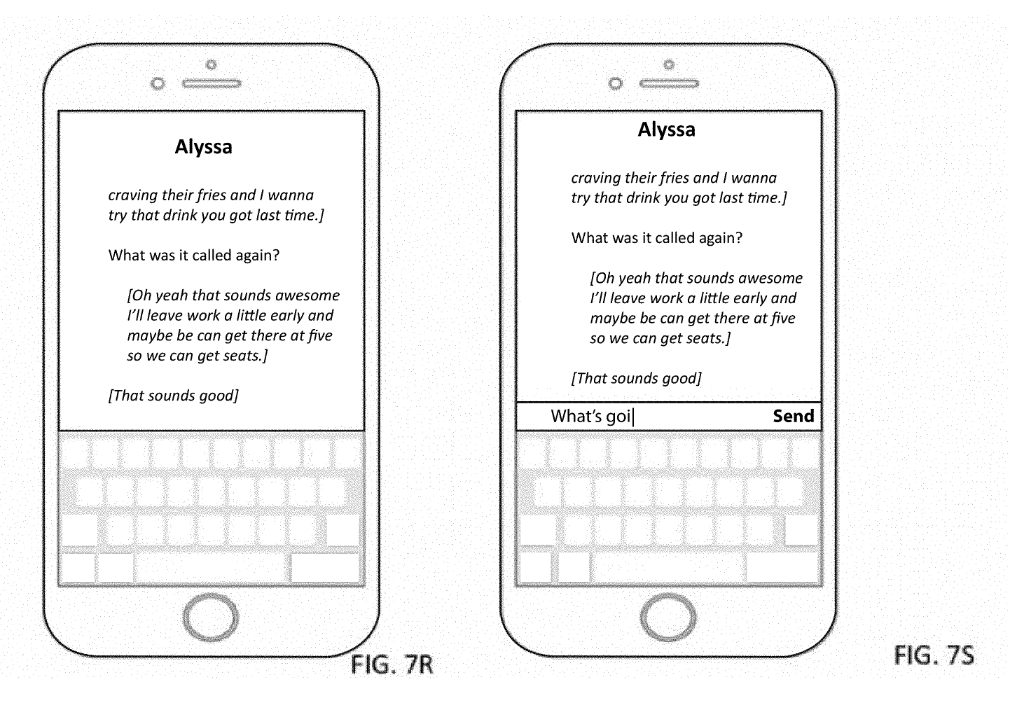

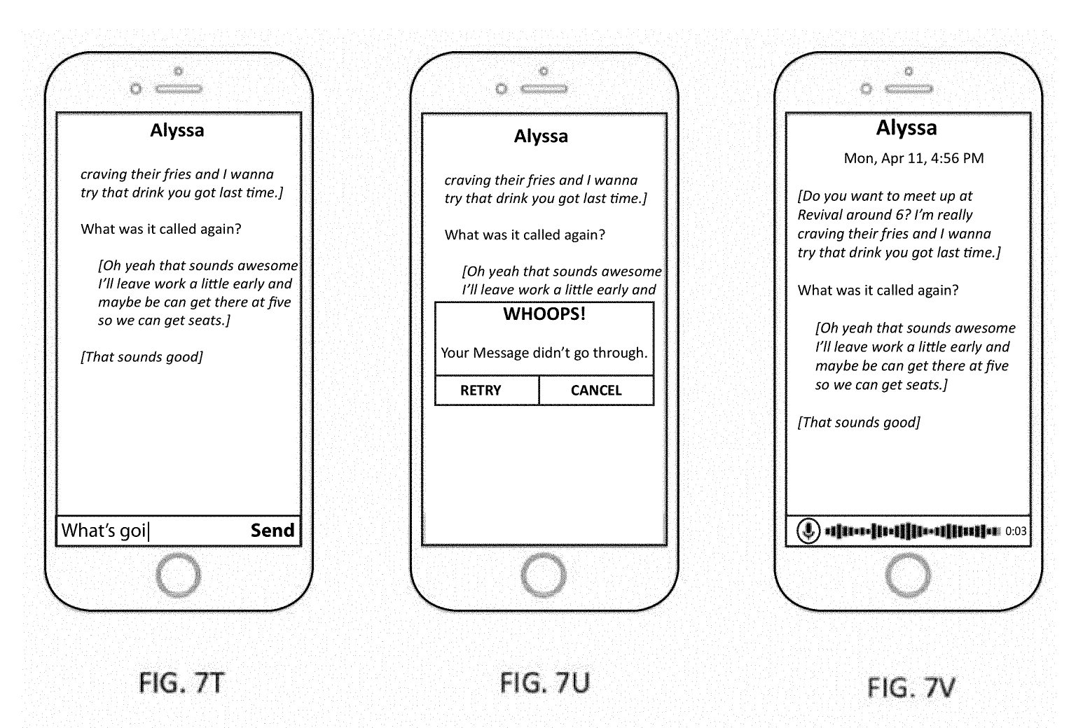

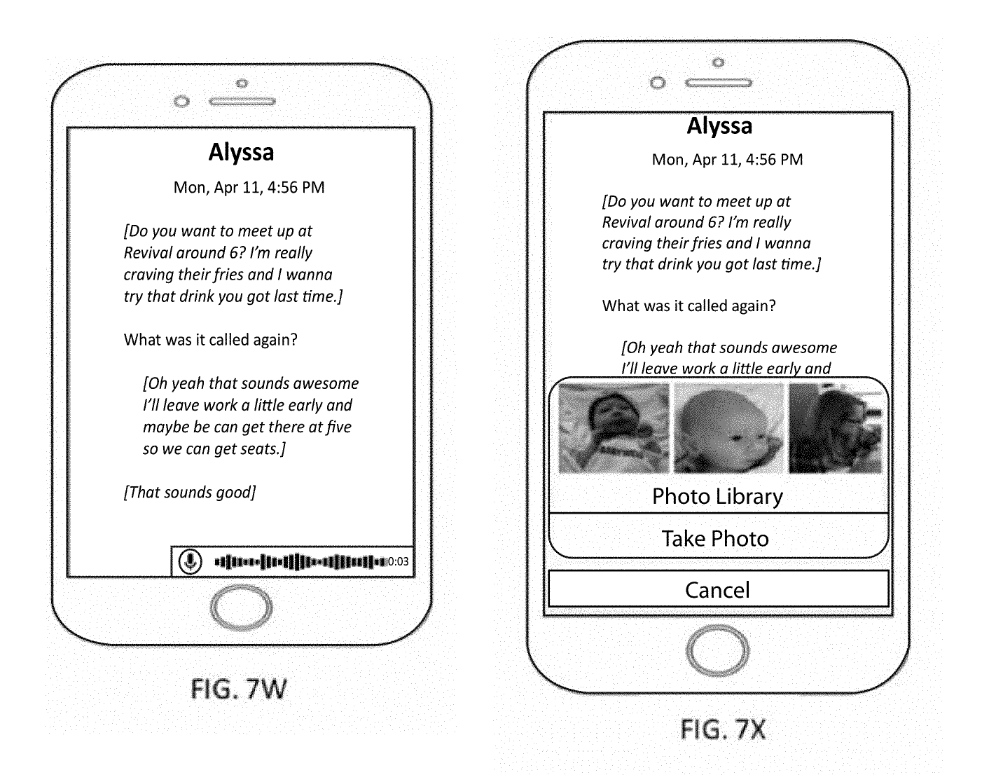

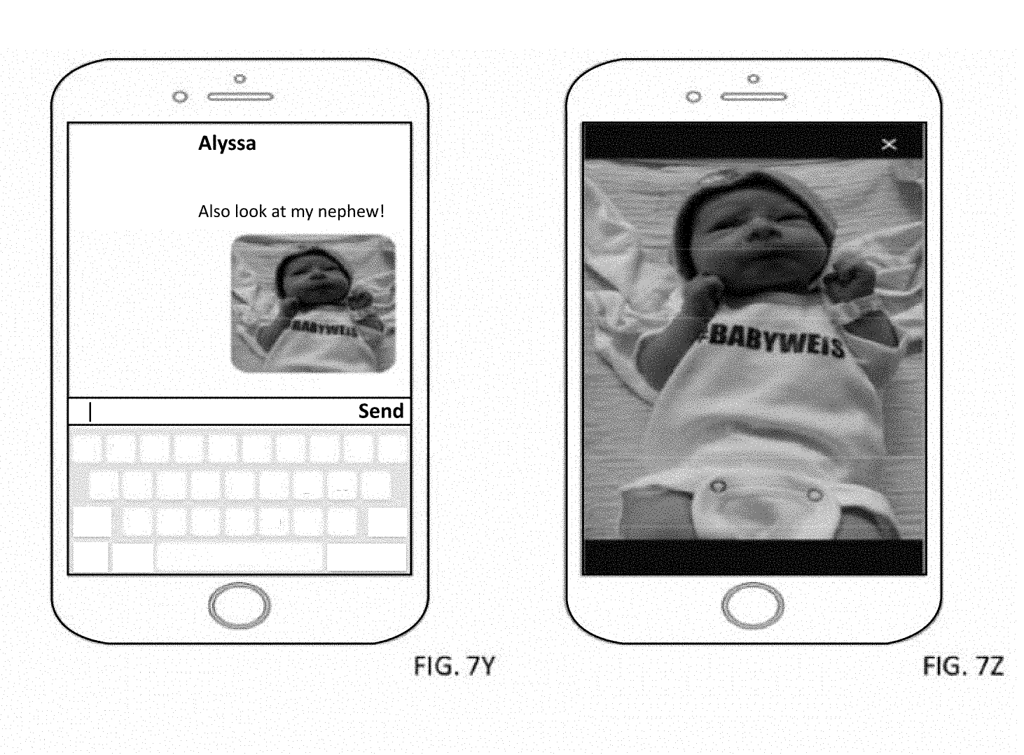

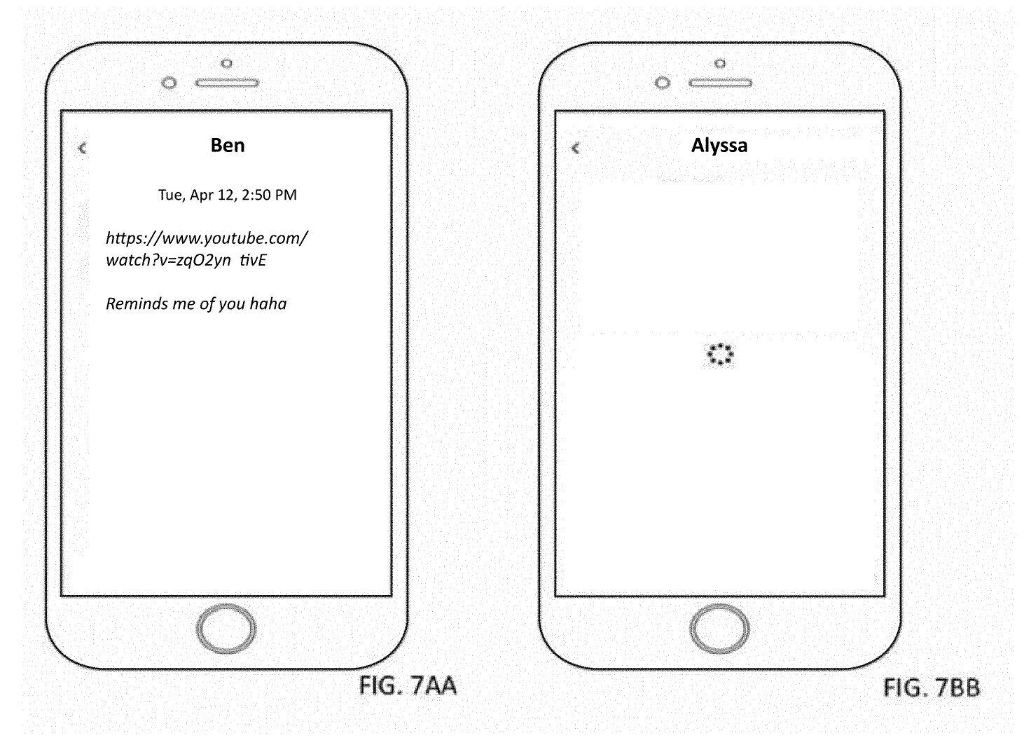

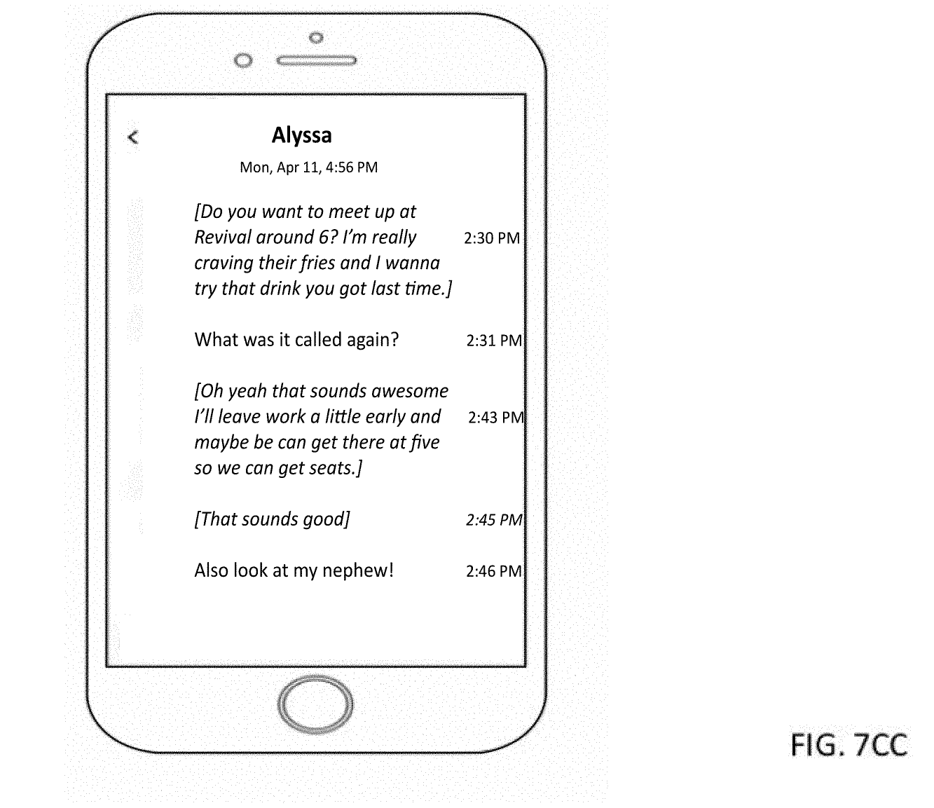

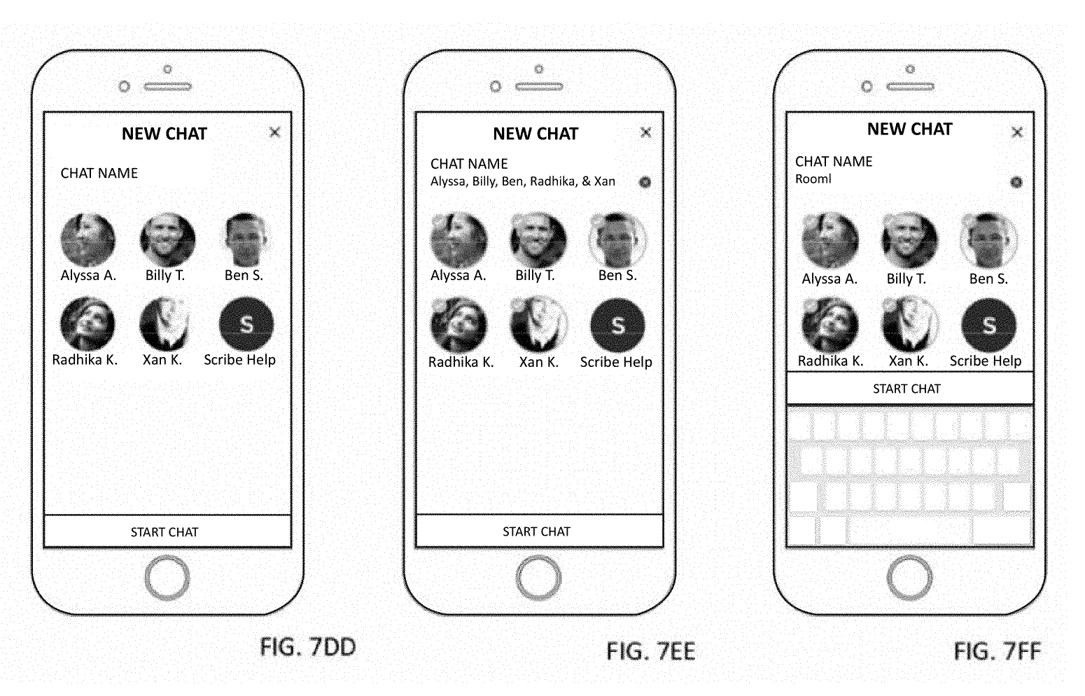

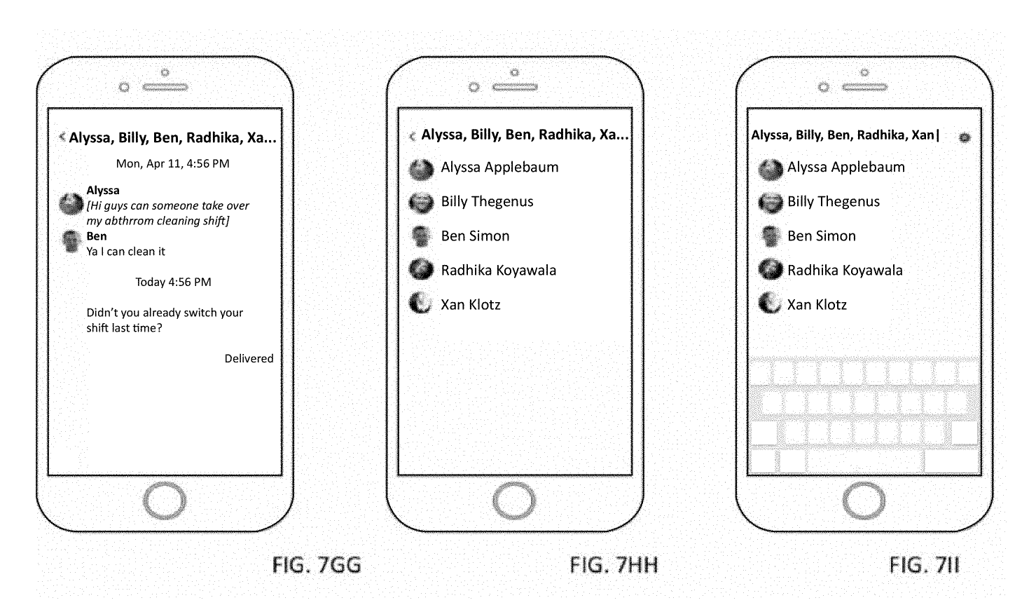

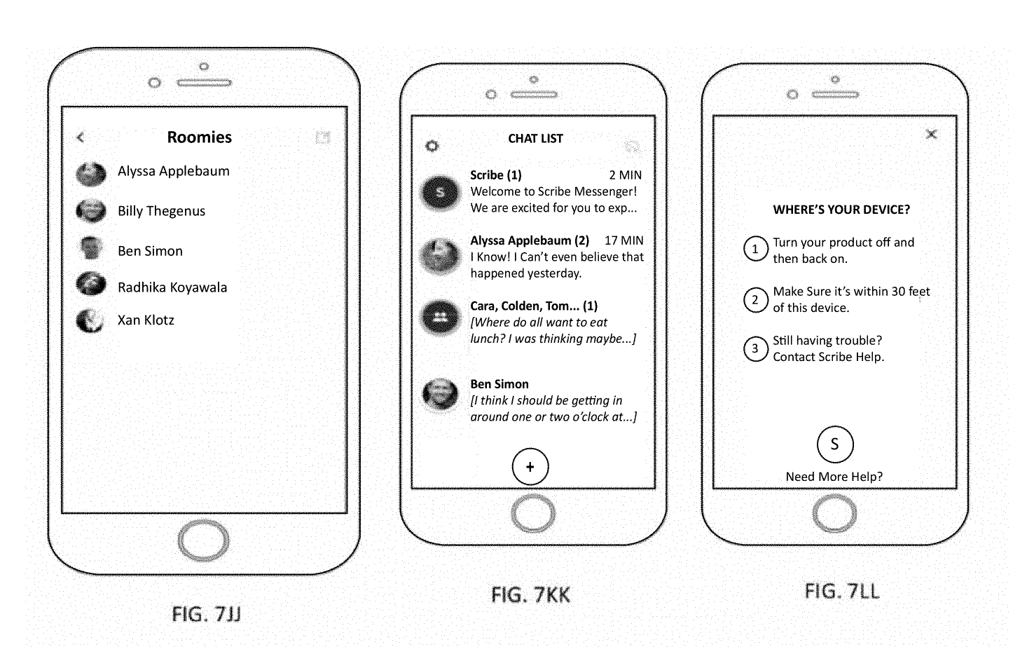

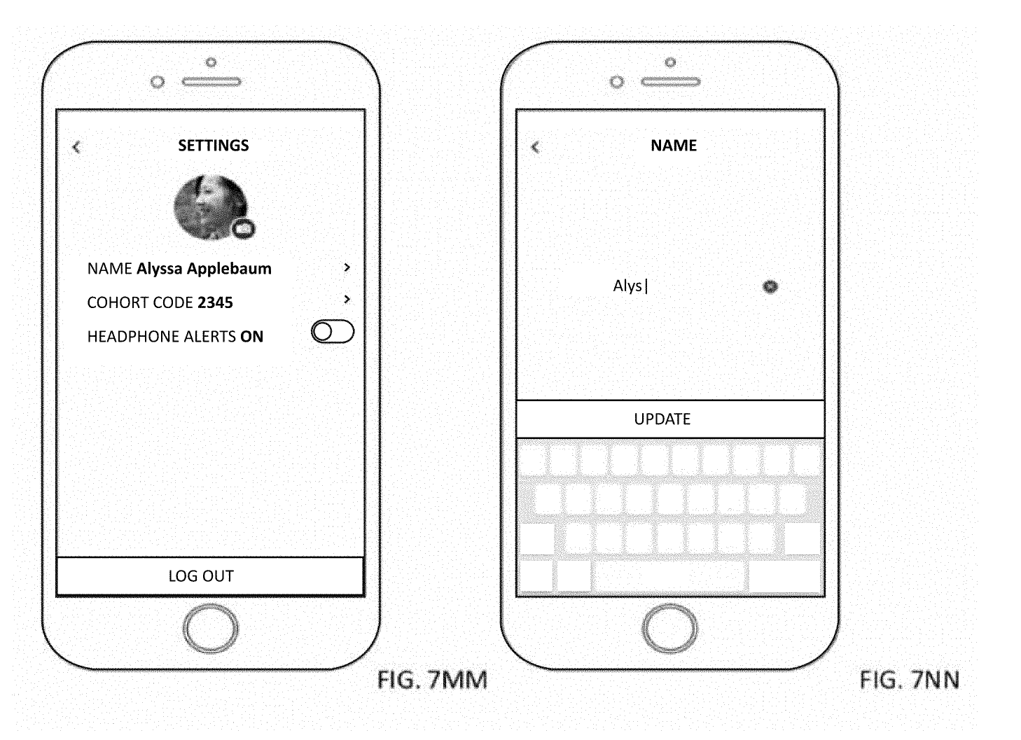

FIGS. 7A-7NN are various screenshots of a user interface of a smartphone displaying chat-related features related to an electronic message exchange, in accordance with some examples.

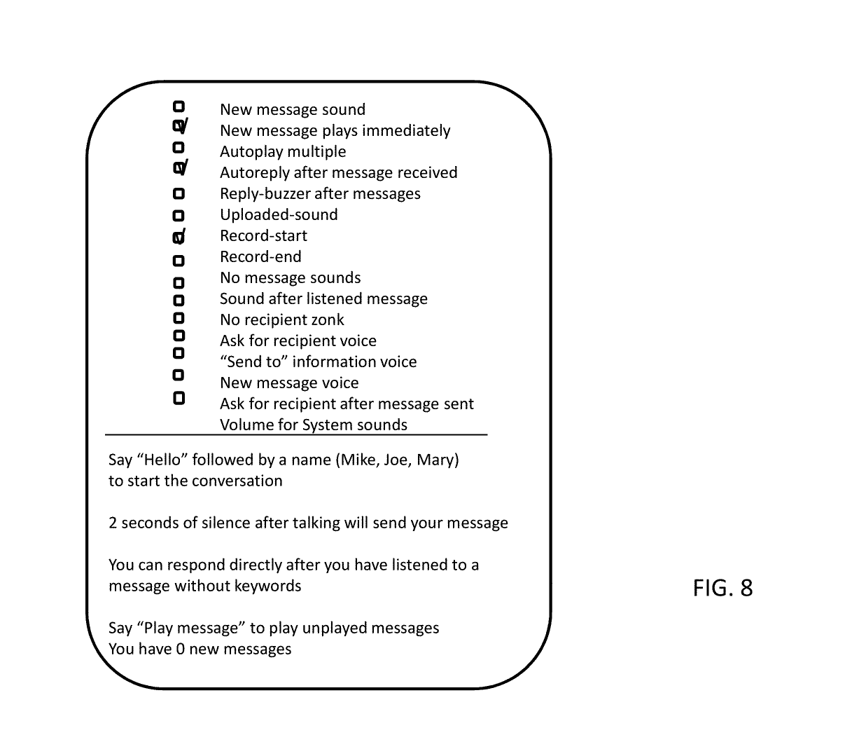

FIG. 8 is a screenshot of a user interface including a set of toggle buttons, in accordance with some examples.

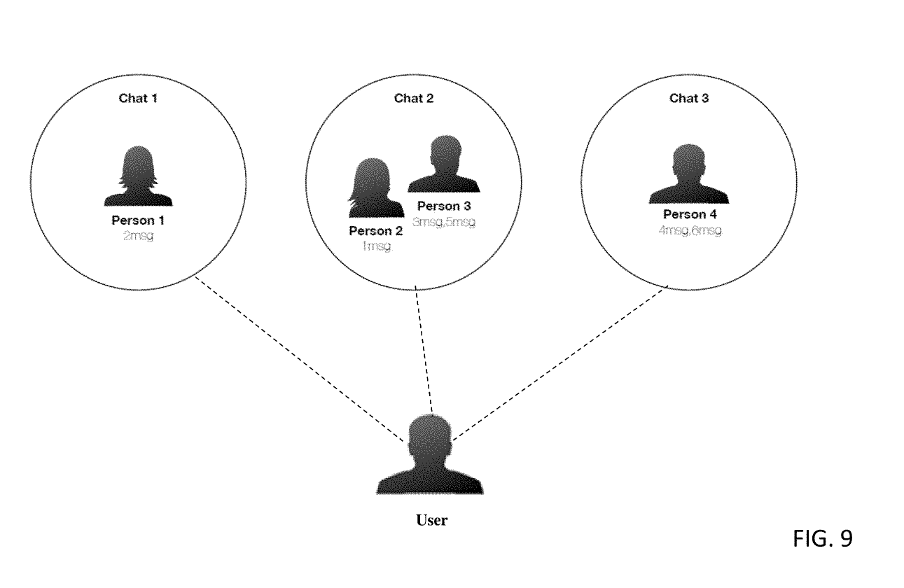

FIG. 9 is a view of an electronic communication exchange between users of a messaging apparatus in accordance with some examples.

### DETAILED DESCRIPTION

In brief overview, described is an application-based messaging platform that aims to improve a user's experience in communicating via text-based and/or voice-based messages. An application is executed at a mobile electronic device such as a smartphone or the like. The application includes an interface that permits a headphone apparatus to communicate with the mobile electronic device. The user may interact with the application via a user interface displayed at the mobile electronic device or the headphone and/or voice commands input to a microphone or other voice communication device or user interface on the headphone. Other devices may equally apply. For example, as an alternative to headphones, a pendant or the like may be used that hangs from a lanyard, and that includes an integral microphone and speaker.

The application-based messaging platform and method addresses a problem with typical messaging systems where voice messages are relegated to a visual/text-message interface paradigm. In order to send and receive messages, a user must look at and interact with a screen. An application described by way of example in the figures may execute at a mobile electronic device with a screen, but may also be multi-modally operated via hands-free voice, via controls on the headphones, and from the application screen itself. In some examples, an application program interface (API) may be present for other instant messaging (IM) applications or the like that allow them to communicate with a headphone to offer features, for example, described herein. A benefit of this application is that, when executed, it allows a user to send or receive a message in a format that is compatible with their current usage context.

For example, a user may ride a bicycle while wearing a headphone, for example, headphone 20 illustrated in FIG. 1. The user may wish to send a message to a friend. If the user had a smartphone but not a headphone, the user would need to send a text message from the smartphone, which is difficult (or dangerous) while riding a bicycle. An application-based messaging system, for example, system 10 illustrated in FIG. 1, on the other hand permits the user to simply press a button on the headphone, or use a voice-activated hands-free command, or activate the headphone in some other manner such as an intentional head movement or other context-related determination, to enable the messaging system to record an audio message. The audio message may be output to the mobile electronic device, and the audio file may be uploaded to an internet cloud or other data repository to be transcribed into a text format. The messaging system may then output both the audio file and transcription of the audio file. The recipient may receive the audio message but might be in a meeting where it is not possible or feasible to listen to it either in an open environment or through headphones. Accordingly, the audio message transcribed in this manner allows the recipient to read the message instead of listening to it. The recipient may also reply to the transcribed message with a text message that would then be sent to the message system and would be sent to the headphone user. The headphone user on the bicycle would receive it in an audio format so that the message is output from a headphone speaker. However, because the system may capture context-related information such as motion-based signals generated when in motion and/or when the headphone is removed from the user's head, the user may not receive a text message due to the danger of reading it while riding the bicycle.

The foregoing example illustrates the benefit of a headphone that permits a hands-free environment to exist while also permitting the user to enjoy the features of instant messaging, so that each participant in a communication exchange, regardless of whether the user is wearing headphones or using a display-based electronic device, may select a preferred mode of communication, i.e., voice and/or text-based communication.

As shown in FIG. 1, an environment for performing electronic messaging may include a messaging system 10 that facilitates and controls an exchange of electronic text and/or voice messages between a headphone 20 and a mobile electronic device 30 such as a smartphone, notebook, laptop computer, and so on regardless of whether the original form of the message is voice or text-based. A network 16 such as a wired, wireless, or other electronic communication network may be used to facilitate data between the messaging system 10, headphone 20, and/or mobile electronic device 30. In other examples, direct communications may be established, for example, according to the Bluetooth protocol or the like. In some examples, the messaging system 10 is a standalone system, i.e., executed at a special-purpose computer that communicates with both the headphone 20 and the mobile electronic device 30. The messaging system 10 may in some examples control a bidirectional communication by executing processes at a special-purpose hardware computer. In particular, hardware processors can be part of one or more special purpose computers that execute computer program instructions, which implement one or more functions and operations of the elements of the environment. In some examples, the messaging system 10 may include multiple computer platforms that communicate with each other via the network 16.

In some examples, the mobile electronic device 30 may be part of a subscription service, for example, with a network service provider offering cellular connectivity. Here, the device's cellular connection may be made to a cloud service or other data repository, where speech-to-text/text-to-speech translation, language translation, and so on may be performed, which provides for a conversion between communication modes. In some examples, some or all of the messaging system 10 is part of an application stored and executed at the mobile electronic device 30, the headphone 20, or both. In other examples, features of the messaging system 10 may be executed at the mobile electronic device 30 and/or headphone 20, for example, converting between different communication modes, translating between various languages, and so on. In other examples, the messaging system 10 is part of a cloud computing environment.

The headphone 20, also referred to as headset, earphones, earpieces, pair of headphones, earbuds or sport headphones, can be wired or wireless for communicating with a network. Although a headphone 20 is shown and described, other electronic audio systems may equally apply, such as Wi-Fi or Bluetooth speakers, open personal audio systems, neck-worn or other body-worn audio systems or the like, and so on. An electronic audio system in some examples may be implemented in a variety of settings or environments, such as a home, commercial location, automobile, or other vehicle, and so on. The headphone 20 may have a single stand-alone headphone or be one of a pair of headphones (each including a respective acoustic driver and ear cup), one for each ear. The headphone 20 may include components of an active noise reduction (ANR) system, but is not limited thereto. The headphone 20 may also include other functionality such as a communications microphone so that it can function as a communication device.

In some examples, the headphone 20 may include an accelerometer, for example, in an earbud, to detect when the bud is being moved towards a user's mouth. The headphone 20 may include a controller or processor that either infers based on a detected movement or outputs processes and outputs context data to the messaging system 10 or cloud computer, which infers based on the detected movement that the user wants to begin recording a message, which may be useful in a hands-free environment.

In some examples, the headphone 20 may include a button or user interface for providing a “push-to-talk” feature, for example, illustrated in FIG. 3. When the “push-to-talk” feature is engaged, the headphone's controller or processor again determines that the user wants to begin recording a message, and thus enables one or more microphones in the headphone to begin listening for the user's speech, and storing the user's speech in memory for further processing.

FIG. 2 is a flowchart illustrating an example of a method 200 for providing bidirectional communication between disparate electronic devices. The electronic devices in this example may include a headphone 20 and mobile electronic device 30 described with reference to FIG. 1.

At block 202, an electronic message may be output from a sending device in a first format. For example, a recording device such as the headphone 20 may generate and output a voice recording, for example, stored and processed as speech data, in a format known to one of ordinary skill in the art. The processed audio may be sent to the mobile electronic device 30, and is output to a local or cloud based service to transcribe the audio message into text, and both the audio and text are output as a single message. In another example, the mobile electronic device 30 may generate and output a text message, for example, in an instant messaging format known to one of ordinary skill in the art. The users of the sending and receiving devices may be identified in each other's contact list or related repository. Context-related data may be included in a contact list. For example, a contact list may include a contact's schedule in the form of calendar entries indicating when the contact is in a meeting. Here, the system 10 may ensure that a text message is sent to the contact, and prohibit the output of audio messages to the contact. In another example, an accelerometer or heart rate sensor of the electronic device, i.e., headphone 20 or mobile electronic device 30, may produce context data that is used by the messaging system 10 to determine that a user in a contact list is exercising. In this example, the system 10 may ensure that an audio message is sent to the user. A contact list may be imported into the messaging system 10 to perform one or more functions, for example, illustrated in the flows of FIGS. 4-6 and/or described in examples below.

At block 204, the first format is transcribed into a second format. For example, the first format is output to the receiving device, for example, the mobile electronic device 30. The first format, for example, audio format, is transcribed into a second format, for example, text format, in a cloud computing environment in communication with the messaging system 10. At block 206, the messaging system 10 may output both the first and second formats to the receiving device.

At block 208, the receiving device presents both formats to the receiving user so they can decide which format is best suited for their current usage context. Thus, in some examples, the receiver of the electronic message is provided with the message in both its original and converted formats. In other examples, the receiving device can also reply in a text format and the system will send this along with a text-speech transcription of the text message to an audio format.

Features of an application-based messaging platform that includes at least one headphone as part of a communication exchange will now be described, as well as shown by way of example at least at FIGS. 4-7NN.

For example, as shown in the flow diagrams of at least FIGS. 4A-4E, hands-free usage is accomplished via the headphone 20 and its connection to a mobile electronic device 30. A voice command may be initiated by a wakeup word capability executed in the headphone 20 which then creates a connection to the messaging application on the mobile phone to send and receive messages hands free. To initiate the recording of a message, in some examples, the headphone 20 may include an accelerometer, gyroscope, or the like to detect when the headphone bud moves toward the user's mouth. In doing so, this movement may be interpreted by the messaging system 10 that the user wishes to begin recording a message. This determination may be made on the headphones 20, whereby a message may be sent to the mobile electronic device 30 that a recording can begin. After the recording is completed, the audio message may be sent to the messaging system 10. In other examples, the mobile electronic device 30 may not be required when the headphone 20 has cell or Wi-Fi connectivity. In other examples, the voice user interface (VUI) on the headphones may detect a keyword, code, or other verbal trigger. For example, a headphone user may orally state “Hello Joe, do you want to grab lunch?” The headphone 20 “wakes up” upon detecting the spoken word “Hello” and records an audio message. It determines it should send a message to Joe at the messaging system 10 asking “do you want to grab lunch?” In some examples, the wakeup word and addressee could be automatically removed from the message that is actually sent. Alternatively, the wakeup word and addressee could be included in the message that is actually sent. In some examples, the system could automatically send a message after silence is detected for a predetermined period of time after the user has finished speaking. Alternatively, a trigger word and/or phrase could be spoken to indicate that the message is ready to be sent (e.g., “Send message” at the end of a spoken message). The trigger word could be automatically discarded from the message that is actually sent.

As illustrated in the flow diagram and screenshots of FIG. 3, the headphone 20 may include a button 21, user interface, or related “push-to-talk” feature for initiating a voice recording as part of a communication exchange with the mobile electronic device 30.

Another feature may include an auto-reply via voice and/or text message. For example, after receiving and outputting an incoming voice and/or text message, a receiving device, i.e., the headphone 20 or the mobile electronic device 30, may automatically begin recording sound to capture a voice reply. The sound may be recorded a predetermined amount of time after the message is received, for example, 5 seconds, after which recording will stop if no speech is detected. This determination may be performed on the mobile electronic device 30, or alternatively, on the headphone 20 connected directly to the internet. The recorded sound is then processed as described above and output as a voice and/or text message via the mobile electronic device 30. In some examples, pre-recorded messages may be automatically output when the user cannot reply. In some examples, the messaging system 10 may store and provide custom messages that a user can select for playback. For example, the user may set an option in the messaging system 10 to send a predefined message. Accordingly, when a message is received by the receiving device, the system 10 could automatically send a response, for example, “Sorry, I can't talk right now.”

In a related example, the user may enable one or more modes or profiles associated with the user's current availability, with an associated pre-recorded automatic reply message for each profile. For example, if the user is in a meeting, the user could enable a “meeting mode” via a user interface at the headphone 20 or the mobile electronic device 30. In this example, the mobile electronic device 30 could automatically reply to an incoming message with a predetermined automatic reply, such as “Can't talk now, in a meeting.”

Another feature relates to a conversational playback, where the messaging system 10 groups messages together, which are executed according to a particular group conversation instead of played according to the order in which the messages are received. This feature allows the listener to listen to all new messages in a conversation in context before playing a subsequent message grouped according to conversation. In some examples, during an audio conversation or after the audio conversation is played, viewed, or otherwise communicated to a user, the user may receive an audio message or display informing the user of the option to respond before the system plays a subsequent conversation. In some examples, a user interface on the headphone 20, the mobile electronic device 30, or the messaging system 10 may execute a conversational playback operation, for example, when producing prerecorded messages or the like regarding a current conversation. A chat details screen may be displayed by the user interface, which includes an option for the user to initiate a playback function, where a relevant message is played back for the user. In doing so, conversation playback is executed, whereby all messages that are part of the conversation are played, for example, displayed as bubbles or the like on the display.

For example, referring to FIG. 9, a user may participate in three different chat sessions. In a first chat session (Chat 1), the user exchanges messages with Person 1. In the second chat session (Chat 2), the user exchanges messages with Person 2 and Person 3. In the third chat session (Chat 3), the user exchanges messages with Person 4. The topic of interest may be common to all three chat sessions, or may be different.

The messaging system 10 may establish the order in which the messages are received, for example, by the user since the last time the user listened to or read a message on the mobile electronic device 30 or other personal computing device having a display or other I/O device. In particular, the system groups ordering according to conversation instead of the sequential order in which messages are received. The following is an example order performed by the messaging system 10:
Person 2 from Chat 2 sends the user a message (Message 1)
Person 1 from Chat 1 sends the user a message (Message 2)
Person 3 from Chat 2 sends the user a message (Message 3)
Person 4 from Chat 3 sends the user a message (Message 4)
Person 3 from Chat 2 sends the user another message (Message 5)
Person 4 from Chat 3 sends the user another message (Message 6)

In this example, the order in which the conversational playback feature plays the messages so the user gains the entire context of a particular chat session rather than having each message play back in the order it was received. In particular, Chat 2 plays back the message from Person 2 (Message 1) followed by the first message from Person 3 (Message 3). Chat 1 plays back the message from Person 1 (Message 2). Chat 3 subsequently plays the two messages from Person 4 (Messages 4 and 6). Also, between the playback of each chat, a reply window may be available that allows the user to respond to a respective chat session before it begins playing a next chat session.

The headphone 20 may include a data buffer so that speech data is temporarily stored, queued, or otherwise preserved, for example, voice recordings stored as speech data to be output from the headphone 20 to the mobile electronic device 30.

During an application-based messaging operation, an electronic message is processed by the messaging system 10 in its original form (e.g., voice/text) and transcribed to its counterpart for display and/or output at the receiving device. For example, if the original message is output by the headphone 20 as a voice message, then it may be received by the mobile electronic device 30 as both voice and text. Here the text version may indicate in some manner that it has been transcribed, e.g., via italics or some other visual indicator of the characters). In some examples, a user can choose how to view the message, for example, via a user interface on the headphone 20, the mobile electronic device 30, or the messaging system 10, depending on what is most convenient for him or her at the time. If a user chooses to listen to a received text message, then the device display may at the same time highlight the displayed words as the audio is output from the device speaker, so the user can listen to the message while also reading the text version of the message.

Alternatively, the user may set a status via the application on the mobile electronic device, e.g. “away,” or “in a meeting,” whereby the mobile device application can detect the best way to provide a message to the user based on his or her status. For example, when the user is in a meeting, and the mobile electronic device receives an incoming voice-based message, the mobile device application can detect that a user is in a situation where he or she could not likely listen to a voice-based message. Thus, the mobile device application could automatically convert the message to a text-based message for display on the headphone and/or the mobile electronic device. The mobile device application could also automatically deliver the message in its original, voice-based format once the user is available to listen to such a message (i.e., when the user's status changes from “in a meeting” to “available” or some other state where the user would be able to listen to a voice-based message). In some examples, a user could indicate (via, e.g., a user interface of the headphone or the mobile electronic device) that he or she is available to listen to a voice-based message in a situation where the system decides to deliver the message in only a text-based format.

Alternatively, the application may use other contextual data (e.g., calendar data, heart rate data, GPS data, accelerometer data, etc.) based on one or more sensors and/or applications residing in the headphone and or mobile electronic device to determine best way to provide the message to the user. For example, based on calendar data, the application may determine that the user is unavailable because he or she is in a meeting (regardless of the user's current status as set via the application). In this instance, the application could determine the most appropriate method for delivering the message to the user, as described above. Similarly, based on heart rate data and/or accelerometer data, the application could determine that a user is exercising, and that a voice-based message would be a more appropriate form of message while the user is exercising. As yet another example, based on GPS and/or accelerometer data, the application could determine that a user is in a car, and that a voice-based message would be a more appropriate form of message in the event the user is driving the car. In some examples, the application may be configured for use by an administrator, who for example, may request to log usage parameters so that the administrator may view what features people are using, how long they are using it for, and so on.

The headphone 20 and/or mobile electronic device 30 may include haptic devices so that custom ringtones, pulses, vibrations and the like are generated that distinguish message sources from each other, and so that the receiver of the message may quickly identify the person sending the message.

In some examples, the system may include a contextual auto-playback feature, permitting the system to make intelligent decisions about when to play messages back to a user. This may include a combination of sensors on the headphones 20 and processors providing intelligence built into the messaging system 10 on what to do when the sensors are in a particular state.

Inputs to the system for activating a contextual auto-playback feature may include but not be limited to: (1) on/off state of headphone 20, where the headphone 20 would detect whether it is on a user's ear vs. off a user's ear and parked (around a user's neck) vs. off a user's ear and not parked; (2) whether the user's voice activity is detected at the headphone (via one or more microphones in the headphones or a VAD module); and (3) the state of the headphones, i.e., detecting whether the user is listening to music or in a phone call.

In some examples, different notifications, prompts, or the like maybe provided to a user's device based on the detected state (i.e., if the headphones are on and the user is listening to music, messages may be provided immediately in a voice and/or text-based format; if the headphones are on and the user is in a phone call or talking, messages may be held until the user's communication is complete, or delivered as a text-based message until the user's communication is complete and the user can receive a voice-based message; and if the headphone is parked, haptic notifications may be used to alert the user to put on the headphones, and the system may then automatically play back the message once the headphones are on).

In some examples, the system may via a network or via access of an application residing on the headphone and/or mobile electronic device coordinate with electronic calendar data, for example, to establish a current user status. For example, if it is established that user is in a meeting, a rules engine executed at the messaging system 10 may instruct the device to generate a text message rather than an audible voice message. The messaging system 10 may send a data signal to the calendar service to determine if the user is busy and would then send auto messages based on that result.

As described above, the headphone 20 may include an accelerometer, gyroscope or other motion sensor. Other related devices may include a heart rate sensor or the like for collecting data to detect whether the user is exercising, etc. The system may use this data, for example, according to a rules engine that establishes that an audible voice message rather than text message is to be provided to the user's device when a sufficiently high pulse rate is detected.

In another example, the electronic device, e.g., headphone 20 or mobile electronic device 30, may include a global positioning satellite device or other location-determining device which gathers location data that can be used to establish the format of the message, for example, different settings for the user at home, work, commuting, and so on. The rules engine may establish that if the user is “busy”, then a non-intrusive notification is to be generated to alert the user that they have a message. The rules engine may also determine the most appropriate form of message (i.e. voice or text) depending on the detected location of the user. Sensors such as haptics in a neckband or headband for headphones that have these features, or tap technology like smart watches may be used to provide the inputs for the rules engine.

Another feature is that a receiving device may receive contextual information about the person with whom the user at the receiving device is communicating. For example, the mobile electronic device 30 and/or headphone 20 of a user sending the message may collect data establishing that the user is listening to music, what music the user is listening to, the user's heart rate, whether the user is exercising, the user's location, whether the user is in a meeting, and so on. This information may be sent along with message data, so that the receiving device can provide this information, so that the receiving user may infer the other person's mood, temperament, state of mind, or other useful information. For example, a text message may include the sender's message data along with a smiley face emoji when contextual information is collected that the user is listening to favorite music.

In some examples, the headphone 20 may include a user interface feature such as a touch screen, scroll wheel, voice user interface (VUI), etc. that provokes scrolling through messages captured in the application. The user may operate the scrolling control which would in turn scroll through messages on the messaging system 10. When the user interface feature is activated, the application may scroll through existing chats from individuals or groups by audibly outputting information about the messages (contact, content of message, date received, etc.) Users may operate some physical control on the headphones or via voice user interface to “scroll through the list of conversations. Once they find the conversation they want they can play back messages in that conversation.

The foregoing may be further illustrated by way of example of the flow diagrams of FIGS. 4-6. Some or all of the elements of the methods illustrated in the flow diagrams may be executed in one or more hardware devices in the environment illustrated in FIG. 1. FIGS. 4A-4E include method steps 102-146 relating to an example of a hands-free operation for initiating a communication exchange. FIGS. 5A-5D include method steps 202-242 relating to an example of a hands-free operation that includes sending a message using a hardware or software button. FIGS. 6A-6D include method steps 302-374 relating to an example of a method for processing a received message in a communication exchange.

FIG. 8 is a screenshot of a user interface for toggling different parts of the user experience. A user may toggle behaviors to streamline the communication process by enabling auto reply, auto play, announcing incoming messages. In some examples, these settings may be executed from an application executed at the mobile electronic device 30, for controlling the overall user experience of using the application with or without headphones.

Examples of toggles may include by not be limited to reconfirming who the user wants to send to or not, whether the language is English or Spanish, whether a new message sound is on or off, whether a new message plays immediately, whether autoplay multiple new messages are generated, whether reply-buzzer after messages are generated, whether “Uploaded” notification sounds are generated, whether to record a start and/or end sound, a “new message” Voice notification or not, and/or playing <n> of <x> voice notification.

Another feature is that the system can share digital images, such as stored photographs or video files, with an attached audio message. The electronic device may process markups, annotations, or other edits of the digital image or video via a touchscreen or other interface. The system can record and share binaural audio from the headphone 20, for example, to assist a user with a current sound the user is experiencing (at a concert, rally, etc.). A related feature is that the system can capture sound from the headphone 20 so that a listener can hear what it is like in various places, for example, a current sound on public streets, in cities/residential areas, at the ocean/beach, in restaurants and other venues, etc. Data from multiple users could be aggregated. The data may be aggregated so a user could experience a concert from various points at a location, for example, in a concert hall. In some examples, locations could be identified by their acoustic signatures. In some examples, videos may be captured by a connected device, and simultaneously or near-simultaneously processed with binaural audio from the headphone 20, for example, to take advantage of the headphone 20 to receive higher quality audio and connected device to get higher quality images and/or video. In a related example, the system may apply beamforming techniques to the microphones on the headphone to improve voice pickup, or synchronize audio with video.

Another feature is that the messaging system may provide message sorting or searching. For example, the system may automatically log links, photos, videos, and proper names (e.g., restaurant names) and numbers (e.g., phone numbers, addresses) for easy sorting and viewing later. In another example, group messages may be generated so that replies do not show up out of context, for example, by sorting messages by time of recording rather than when sent, for example, shown in the screenshots of FIG. 6. Contact groups may be created by a user and stored at a local data repository, for example, a storage device of the mobile electronic device 30, and/or a central database, for example, in communication with the messaging system 10. FIGS. 6 and 7 include screen shots of a user interface for creating and/or managing a contact group.

In some examples, an electronic communication between a headphone 20 and mobile electronic device 30 may automatically switch from text-based or voice-based messaging to live conversation via, for example, a phone call (asynchronous to synchronous mode). In other examples, the messaging system 10 can detect when an appropriate time in the conversation would be to switch to a direct phone call based on number of messages exchanged, timing of the messages, history of the people who are chatting, etc. For example, when a user in a communication hangs up, the exchange may automatically return to asynchronous mode.

In some examples, the messaging system 10 integrates synchronous and asynchronous messaging. For example, a mobile device user may activate an electronic paging feature to output a message for receipt by one or more other mobile device users. Some mobile device users may be co-located in a building or other common area and their mobile devices may be accessible via a Wi-Fi (or other network) connected speaker. These users may receive the page in real-time. However, other users may not be in electronic communication with the Wi-Fi connected speaker, and therefore unavailable to receive the page in real-time. These users, however, may receive at their mobile devices a notification that a message was sent. The mobile devices of these other users may communicate with a communication network or provide direct communication via Bluetooth or the like. The system 10 may provide a feature where these other users may initiate playback to hear the message. This message may include a recording of the original message sent via paging feature to the co-located users.

In a related example, the messaging system 10 integrating synchronous and asynchronous messaging may provide a feature for the intimate sharing of music or audio content. For example, a user may utter a message into the headphone 20 or mobile device application that includes a command to share a music stream with a recipient. The recipient receives at a mobile electronic device the message. If the recipient accepts, then the user can join the initiating user's audio stream and listen in real-time along with the initiating user. If the receiving user declines or does not respond to the message, then the user may establish a synchronous communication, for example, receiving a synchronous message that the initiating user has shared a song with the receiving user, and can listen to it independently of the initiating user.

In some examples, the system includes auto-language detection, wherein the system can determine a preferred language of a receiving user from context data (contacts, chat history, etc.). A user may pre-set language preferences. The system may include a language translation device, for example, to translate speech detected by the headphone or smartphone microphone.

In some examples, the system may include a speech augmentation feature, where if a person is talking in an environment where they must talk quietly, other information may be used to inform system of what the user actually said (i.e. use camera on phone to read lips).

In some examples, in a setup operation, a user may desire one or more of the following:
Sign up as a user of the system
Only users of the application can use the application to send/receive messages to each other, as whole group, individually, and new sub-group combination
Import contacts from a contact list to use with the application
Create a profile that includes the user's name or other identifier as it appears to others and an avatar
Upload a photo from the user's phone's photo library to use as an avatar or the like
Create new chats, either group or individual, using the user's voice and manually on the phone
Configure a wireless headphone to work with the application allowing the user to record a voice and hear notifications and previously recorded messages using the headphone
Configure a Bluetooth hardware button or the like in the application that allows the user to press and hold to activate recording and sending and playing back messages

In some examples, a user may desire to initiate sending a message according to one or more of the following:
Provide a music auto pause when the user speaks or types a wake-up word or activates a voice session via a hardware button or from a button in the application
Initiate sending an audio message to an individual or group using only the user's voice from the user's headphones
Initiate sending an audio message to an individual or group from the user's headphones using a press-to-talk button to initiate the interaction
Initiate sending an audio message to an individual or group using the on-screen interface on the user's mobile device with or without headphones
Create new chats using the user's voice, for example, either activating a Bluetooth button or the like or without activating the button, when initiating a message
Create new chats using an in-screen application interface
Notify the user if the person or chat that the user is sending a message to is not in the user's contact list or in an existing chat
Confirm the last name of person if more than one contact result has same first name
Operate the system and send a message in English or Spanish, or any other language
Use the user's voice to initiate sending a message to a contact by canceling sending a message while/after creating it via voice or from the mobile device
Receive verification on-screen and via sound through the user's headphones that the message was sent successfully or not
View a list of previously sent messages and be able to play back any previous message in the thread from the application.
Delete conversation/messages/chats
Have the system clearly articulate, by audio, visual, and/or tactile messages, when it is listening for the user to speak (with tones, voice prompts or both)
Create a message as quickly as possible with minimal prompts and language using the user's voice
Retry or cancel sending a message if the system doesn't parse the voice input correctly

In some examples, a user may desire to receive and reply to a message according to one or more of the following:
Receive a notification that the user received a message. The notifications should be audible through the user's headphones and/or displayed on a mobile device, noting that notifications could be voice prompts and/or tones, even if the messaging app is not running or is not the active application
Receive a notification from the application that the user has new messages
Receive, replay and be notified in English or Spanish, of the language, for example, an application toggle language
Identify the group or individual the message is from (announce or use tones that identify the group or individual).
Use the user's voice to initiate playing back the message
Activate the Bluetooth button or the like and/or use voice to initiate playing back the message
Use the mobile device to initiate playing back a message
Use voice to reply to a message
Use the Bluetooth button or the like and voice to replay a message
Use a mobile device to reply to a message
Send an audio message reply using only the user's voice
Send an audio message reply using both the Bluetooth button or the like and the user's voice
Send an audio message reply using a mobile device screen and the user's voice
Cancel sending a message while/after creating using the user's voice
Cancel sending a message while/after creating using the Bluetooth button or the like
Cancel sending a message while/after creating it via the mobile device's screen
Receive verification on-screen and through headphones, for example, via voice prompt and/or tones, that the message was sent successfully or not
View a list of previously sent messages and be able to play back any previous message in the thread
Configure the system to articulate when the user should speak, for example, with tones, voice prompts or both
Listen and reply to a message as quickly as possible with minimal prompts and language without the user's hands
Retry or cancel sending a message if the system doesn't parse the voice input correctly
Provide the ability to initiate a voice or video call

In some examples, a user may desire to manage an application according to one or more of the following:
Create new groups or individual chats
Set a group name (or use a default) when the user creates a group chat
Set an avatar (or use a default) when the user creates a group chat
Change the avatar on previously created group chats
Change the name on previously created group chats
Change a user's avatar after creating a profile
Set a notification sound for a chat
Mute notifications per conversation

A number of implementations have been described. Nevertheless, it will be understood that the foregoing description is intended to illustrate and not to limit the scope of the inventive concepts which are defined by the scope of the claims. Other examples are within the scope of the following claims.

What is claimed is:

1. A method for exchanging electronic messages between a mobile electronic device of a first party of a communication including the electronic messages and a mobile electronic device of a second party of the communication, comprising:
outputting an electronic message in a first format from one of the mobile electronic devices;
reading the electronic message in the first format;
transcribing the electronic message into a second format;
outputting the electronic message in both the first format and the second format to the other of the mobile electronic devices; and
selecting by a user of the other of the mobile electronic devices at least one of the first and second formats.

2. The method of claim 1, wherein the mobile electronic device of the first party comprises a headset.

3. The method of claim 1, wherein the mobile electronic device of the second party comprises a mobile phone.

4. The method of claim 1, wherein the first format is a voice recording and the second format is a text message.

5. The method of claim 1, wherein the other of the mobile electronic devices includes a user-selectable feature for selecting whether to receive the message in the first format or the second format.

6. The method of claim 1, further comprising:
determining from context data a language of preference of the other of the mobile electronic devices; and
translating the content of the electronic message into the second format, the second format in the language of the preference.

7. The method of claim 1, further comprising:
processing context data to determine whether to deliver the message in the first format or the second format to the other of the mobile electronic devices.

8. The method of claim 1, further comprising automatically switching from an asynchronous mode to a synchronous mode during the communication.

9. The method of claim 8, wherein the asynchronous mode includes a text-based or voice-based messaging exchange, and the synchronous mode includes a real-time or near real-time communication.

10. The method of claim 1, further comprising generating an auto reply, wherein in response to receiving the electronic message by the other of the mobile electronic devices, the method further includes:
automatically recording sound to capture a voice reply;
outputting the recorded sound to a messaging system;
transcribing the recorded sound into a text message; and
outputting the text message.

11. The method of claim 1, wherein the message in the first format is output to a cloud based transcription service to be transcribed.

12. The method of claim 1, further comprising grouping a plurality of electronic messages according to a predetermined conversation.

13. The method of claim 1, wherein the electronic messages include both synchronous and asynchronous messages, and wherein the method further comprises combining the synchronous and asynchronous messages in the communication.

14. A messaging platform, comprising:
at least one input for receiving an electronic message in a first format from one of a headset and a mobile electronic device; and
a special-purpose processor for determining whether the receiving other of the headset and the mobile electronic device is configured for processing the electronic message in the first format, and for providing to the other of the headset and the mobile electronic device at least one of the electronic message converted into a second format or in the first format.

15. The messaging platform of claim 14, wherein one of the first format and the second format is a voice recording and the other of the first format and the second format is a text message.

16. A system for exchanging electronic messages, comprising:
a headset;
an application stored at and executed by a mobile electronic device; and
a messaging system for exchanging voice messages processed by the headset and a combination of voice and text messages processed by the application.

17. The system of claim 16, wherein the messaging system converts a voice message of the voice messages processed by the headset to a text message for receipt by the mobile electronic device.
